(19) United States
(12) Patent Application Publication
(10) Pub. No.: US 2017/0256236 A1
(43) Pub. Date: Sep. 7, 2017

(54) PORTABLE ELECTRONIC DEVICE AND DISPLAY METHOD

(71) Applicant: SEIKO EPSON CORPORATION, Tokyo (JP)

(72) Inventors: Kazuhiro SHIHO, Shiojiri-shi (JP); Yoshihiro YAMAMURA, Azumino-shi (JP)

(73) Assignee: SEIKO EPSON CORPORATION, Tokyo (JP)

(21) Appl. No.: 15/444,846

(22) Filed: Feb. 28, 2017

(30) Foreign Application Priority Data
Mar. 1, 2016 (JP) 2016-038785

(51) Int. Cl. G09G 5/10; G06F 1/16; G06F 3/01

(52) U.S. Cl. CPC G09G 5/10; G06F 3/015; G06F 1/163; G09G 2360/144; G09G 2354/00

(57) ABSTRACT

A portable electronic device includes a display unit, and a processor that operates in a mode that improves lighting frequency or lighting brightness of lighting of the display unit during a period from sunset to sunrise than the lighting frequency or the lighting brightness of the lighting during a period from sunrise to sunset, and is able to adjust a start time or an end time of a period for improving the lighting frequency or the lighting brightness of the lighting in the mode, depending on input information.

### BACKGROUND

1. Technical Field

The present invention relates to a portable electronic device and a display method.

2. Related Art

Wrist devices which are portable devices may be equipped with modes for minimizing the lighting frequency of a backlight. A night mode is described as one of the modes of the wrist device in “GARMIN (registered trademark) ForeAthlete (registered trademark) 220J operation manual”, issue year: 2014, issuer: Iiyo.net Co., Ltd. If the wrist device is set to the night mode, a backlight lights up when a key operation or the like is performed during training from sunset to sunrise, but the backlight does not light up even when the key operation or the like is performed during training from sunrise to sunset. Therefore, according to the night mode, since a time zone during which lighting of the backlight is prohibited is limited only to the daytime, it is possible to prevent unnecessary power consumption during the daytime training without impairing the visibility in the night training.

However, it is recognized that the function of the night mode could be insufficient depending on the environment where the user is located. Hereinafter, in this specification, an operation mode for switching the lighting frequency or the lighting brightness of lighting between the daytime and the night is referred to as a “night mode”.

### SUMMARY

An advantage of some aspects of the invention is to improve usability of a portable electronic device and a display method that can operate in a night mode.

The invention can be implemented as the following forms or application examples.

### APPLICATION EXAMPLE 1

A portable electronic device according to this application example includes a display unit, and a processor that operates in a mode that improves lighting frequency or lighting brightness of lighting of the display unit during a period from sunset to sunrise than the lighting frequency or the lighting brightness of the lighting during a period from sunrise to sunset, and is able to adjust a start time or an end time of a period for improving the lighting frequency or the lighting brightness of the lighting in the mode, depending on input information.

The processor operates in the mode that improves the lighting frequency or the lighting brightness of the lighting during the period from sunset to sunrise than the lighting frequency or the lighting brightness of the lighting during the period from sunrise to sunset. Therefore, the portable electronic device enables a reduction in power consumption of the display unit during the daytime and securing visibility of the display unit during the night.

However, depending on the environment where the user is located, the timing at which the periphery of the user starts to become dark does not necessarily match the sunset time, and the timing at which the periphery of the user starts to brighten does not necessarily match the sunrise time. Therefore, the start time or the end time of the period for improving may be inappropriate depending on the environment where the user is located.

However, the processor of this application example can adjust the start time or the end time of the period for improving the lighting frequency or the lighting brightness of the lighting in the mode, depending on input information. Therefore, in the portable electronic device of this application example, the start time or the end time of the period for improving is unlikely to be inappropriate, and usability can be improved.

### APPLICATION EXAMPLE 2

The portable electronic device according to this application example may further include an operation unit, and the input information may include information which is input through the operation unit.

Therefore, in the portable electronic device of this application example, the start time or the end time of the period for improving can be adjusted depending on the input information.

### APPLICATION EXAMPLE 3

In the portable electronic device according to this application example, the input information may include information which is generated based on an output of a sensor.

Therefore, in the portable electronic device of this application example, the start time or the end time of the period for improving can be adjusted depending on the output of the sensor.

### APPLICATION EXAMPLE 4

The portable electronic device according to this application example may further include a communication unit, and the input information may include information which is received through the communication unit.

Therefore, in the portable electronic device of this application example, the start time or the end time of the period for improving can be adjusted depending on the received information.

### APPLICATION EXAMPLE 5

In the portable electronic device according to this application example, the input information may include information on environment where a user is located.

Therefore, according to the portable electronic device of this application example, it is possible to reduce power consumption of the display unit and maintain visibility of the display unit, depending on the environment where the user is located, that is, the usage environment of the portable electronic device.

### APPLICATION EXAMPLE 6

In the portable electronic device according to this application example, the input information may include information on terrain or weather.

Therefore, in the portable electronic device of this application example, the start time or the end time of the period for improving can be adjusted depending on the terrain or the weather.

### APPLICATION EXAMPLE 7

The portable electronic device according to this application example may be attachable to a user's arm or wrist .

Therefore, the user can use the portable electronic device with the same feeling as that of the wrist watch.

### APPLICATION EXAMPLE 8

A display method according to this application example is a display method related to a display unit of a portable electronic device, the method causing a computer to operate in a mode that improves lighting frequency or lighting brightness of lighting of the display unit during a period from sunset to sunrise than the lighting frequency or the lighting brightness of the lighting during a period from sunrise to sunset, and adjust a start time or an end time of a period for improving the lighting frequency or the lighting brightness of the lighting in the mode, depending on input information.

The computer operates in the mode that improves the lighting frequency or the lighting brightness of the lighting during the period from sunset to sunrise than the lighting frequency or the lighting brightness of the lighting during the period from sunrise to sunset. Therefore, the display method of this application example enables a reduction in power consumption of the display unit during the daytime and securing visibility of the display unit during the night.

However, depending on the environment where the user is located, the timing at which the periphery of the user starts to become dark does not necessarily match the sunset time, and the timing at which the periphery of the user starts to brighten does not necessarily match the sunrise time. Therefore, the start time or the end time of the period for improving may be inappropriate depending on the environment where the user is located.

However, the computer of this application example can adjust the start time or the end time of the period for improving the lighting frequency or the lighting brightness of the lighting in the mode, depending on input information. Therefore, according to the display method of this application example, the start time or the end time of the period for improving is unlikely to be inappropriate, and usability can be improved.

### APPLICATION EXAMPLE 9

A display program according to this application example is a display program related to a display unit of a portable electronic device, the program causing a computer to operate in a mode that improves lighting frequency or lighting brightness of lighting of the display unit during a period from sunset to sunrise than the lighting frequency or the lighting brightness of the lighting during a period from sunrise to sunset, and adjust a start time or an end time of a period for improving the lighting frequency or the lighting brightness of the lighting in the mode, depending on input information.

The computer operates in the mode that improves the lighting frequency or the lighting brightness of the lighting during the period from sunset to sunrise than the lighting frequency or the lighting brightness of the lighting during the period from sunrise to sunset. Therefore, the display program of this application example enables a reduction in power consumption of the display unit during the daytime and securing visibility of the display unit during the night.

However, depending on the environment where the user is located, the timing at which the periphery of the user starts to become dark does not necessarily match the sunset time, and the timing at which the periphery of the user starts to brighten does not necessarily match the sunrise time. Therefore, the start time or the end time of the period for improving may be inappropriate depending on the environment where the user is located.

However, the computer of this application example can adjust the start time or the end time of the period for improving the lighting frequency or the lighting brightness of the lighting in the mode, depending on input information. Therefore, according to the display program of this application example, the start time or the end time of the period for improving is unlikely to be inappropriate, and usability can be improved.

### BRIEF DESCRIPTION OF THE DRAWINGS

The invention will be described with reference to the accompanying drawings, wherein like numbers reference like elements.

FIG. 1 is a diagram for explaining an overview of an electronic device in a first embodiment.

FIG. 2 is a functional block diagram for explaining a configuration example of a system including the electronic device.

FIG. 3 is a flowchart for explaining a processing example of an information terminal relating to data transfer with the electronic device.

FIG. 4 is a flowchart for explaining a processing example of the information terminal relating to information communication with a server.

FIG. 5 is a diagram for explaining a night mode.

FIG. 6 is a diagram for explaining examples of various environments where a user can be located.

FIG. 7 is a diagram for explaining manual adjustment of a lighting permission period.

FIG. 8 is a diagram for explaining an example of terrain data (opening degree map).

FIG. 9 is a diagram for explaining an example of weather data (brightness degree map).

FIG. 10 is a diagram for explaining an example of a calculation table of an adjustment amount.

FIG. 11 is a flowchart of a processing example of the electronic device in a case where a night mode function and an automatic lap function are turned on.

FIG. 12 is a functional block diagram for explaining a configuration example of a system of a modification example.

FIG. 13 is a flowchart of a processing example of the electronic device of the modification example.

### DESCRIPTION OF EXEMPLARY EMBODIMENTS

Hereinafter, preferred embodiments of the invention will be described in detail with reference to the drawings. In addition, the embodiments described below do not unfairly limit the contents of the invention described in the appended claims. Further, not all of the configurations described below are necessarily essential constituent elements of the invention.

### 1. Embodiment of Electronic Device

### 1-1. Overview of Electronic Device

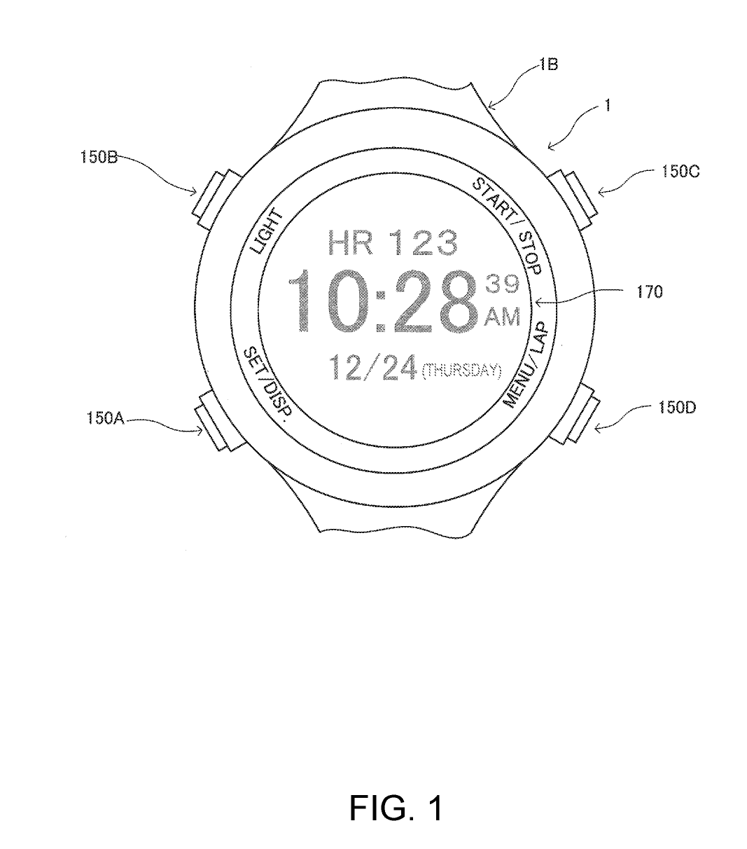

FIG. 1 is a diagram for explaining an overview of an electronic device in a first embodiment.

As illustrated in FIG. 1, an electronic device 1 (an example of a portable electronic device) of the present embodiment is a wearable portable information device attached to a part of the user's body. The electronic device 1 is installed, for example, in the part from the elbow to the hand (forearm) so that the user can see it when necessary.

In the example illustrated in FIG. 1, the electronic device 1 is configured as a wearable portable information device of a wrist type (a wrist watch type) and has a belt 1B which is a wearing tool for attaching the electronic device 1 to a user's wrist. Further, for example, four operation buttons 150B, 150A, 150C, and 150D which are constituted by mechanical switches are provided on the outer edge portion of the display unit 170 of the electronic device 1.

Here, if each direction with the center of the display unit 170 as a reference is expressed by time in a case where the display unit 170 is assumed to be a dial of a 12 hour hand time piece, in FIG. 1, in the display unit 170, the position of the operation button 150B is the 10 o'clock position of the display unit 170, the position of the operation button 150A is the 8 o'clock position of the display unit 170, the position of the operation button 150C is the 2 o'clock position of the display unit 170, and the position of the operation button 150D is the 4 o'clock position of the display unit 170. The shape of the display unit 170 is not limited to the disk shape illustrated in FIG. 1, and the positions of the operation buttons 150B to 150D and the number thereof in the display unit 170 are not limited to those illustrated in FIG. 1.

FIG. 1 illustrates a state when the electronic device 1 is in the time display mode. For example, the current date and time, the day of the week, the morning or afternoon, and the like are displayed as images of letters and numbers on the display unit 170 in the time display mode.

A function for the user to input an instruction to switch the mode of the electronic device 1 to the electronic device 1 is allocated to the operation button 150A. However, when the electronic device 1 is in a menu display mode (during a period when the menu screen is displayed), a function for the user to input a determination instruction (setting instruction) to the electronic device 1 is assigned to the operation button 150A.

For example, a function for the user to input a light turning-on instruction and a light turning-off instruction of a light to the electronic device 1 is allocated to the operation button 150B.

A function for the user to input a measurement start instruction and a measurement end instruction of performance measurement (including measurement of split time, an automatic lap function, or the like) to the electronic device 1 is allocated to the operation button 150C. Further, when the electronic device 1 is in the menu display mode (during a period when the menu screen is displayed), a function for inputting an instruction to move the cursor upward on the menu screen to the electronic device 1 is allocated to the operation button 150C.

A function for inputting a call instruction of the menu screen to the electronic device 1 is allocated to the operation button 150D. However, during the performance measurement, a function for the user to input a lap recording instruction (a manual lap separation instruction) to the electronic device 1 is allocated to the operation button 150D. When the electronic device 1 is in the menu display mode (during a period when the menu screen is displayed), a function for inputting an instruction to move the cursor downward to the electronic device 1 is allocated to the operation button 150D.

The above electronic device 1 operates as a performance measurement device as well as a time piece. The electronic device 1 as the performance measurement device acquires user performance data (performance measurement) utilizing various sensing functions. In the following, the user performance data is also simply referred to as “performance data”. Hereinafter, a case where the user is a runner and user performance data useful for running is acquired is taken as an example.

The user performance data includes, for example, progress information on the exercise of the user in the travel course and lap information on the exercise of the user for each section of the travel course.

“Travel course” refers to a course on which the user runs, and refers to a period from a measurement start time to a measurement end time, or a route from the measurement start point to the measurement endpoint. In other words, the travel course includes both the concept of a distance (a scheduled distance or a scheduled route) and the concept of a time (scheduled time).

“Progress information” is user performance data in a section from the start point (start point or start time) of the travel course to the current point (current point or current time). The progress information includes, for example, a cumulative travel distance of the section, a cumulative travel time (split time) of the section, the average travel speed of the section, an average heart rate of the section, and the like.

“Lap information” is user performance data in a section (hereinafter, referred to as a lap section) which is formed by dividing a travel course by a predetermined time or a predetermined distance. In a case where the lap section is a distance section, the lap information includes a travel time (lap time) in the lap section, an average travel speed (lap pace) in the lap section, an average heart rate in the lap section (lap heart rate), and the like. Further, in a case where the lap section is a time section, the lap information includes a travel distance (lap distance) in the lap section, an average travel speed (lap pace) in the lap section, an average heart rate in the lap section (lap heart rate), and the like.

For generation (measurement) of the user performance data, a pulse sensor, an acceleration sensor, an angular velocity sensor, a GPS sensor (GPS: Global Positioning System), a geomagnetic sensor, an atmospheric pressure sensor, and the like which will be described later are used. However, for the generation (measurement) of the user performance data, other sensors may be combined, or some sensors may not be used. “Pulse” is a pulsation transmitted to the artery at each part of the body due to a change in the beat (heartbeat) at which the heart sends blood out to the whole body. In the following description, the part described as “pulse” can be read as “heartbeat” as appropriate in a technically substitutable range.

Then, the electronic device 1 logs various user performance data. Here, “logging” refers to recording user performance data. “Performance data logging” refers to recording the history of performance data (that is, recording data in a time series or in a form in which individual data can be specified).

### 1-2. Overview of User Behavior

In advance preparation, the user displays a menu screen on the display unit 170 of the electronic device 1, and inputs data (user body data) related to his/her body such as height, weight, age, sex, body fat percentage and the like. Further, the user performs settings related to the automatic lap function (setting of a lap section, or the like) on the menu screen and returns the electronic device 1 to the time display mode. In addition, the user may input the target data (user target data) together with the body data. The user target data is, for example, a target value of a lap time, a target value of a lap distance, a target value of a lap heart rate, and the like.

hereafter, the user stands at the start point of the travel course, for example, with the electronic device 1 worn on his arm, presses the operation button 150C of electronic device 1 at a start timing (a timing at which the user starts traveling or a timing of start signaling), instructs the electronic device 1 to start performance measurement, and starts traveling. After that, basically, the electronic device 1 continuously displays a normal measurement screen, and notifies the user of the lap information of the latest lap section (a lap time, a lap pace, a lap heart rate, target achievement thereof, or the like) by sound, vibration, images, light, color, or a combination thereof, at a timing when the separation timing of the lap section arrives.

Thereafter, upon reaching the endpoint of the travel course, the user presses the operation button 150C of the electronic device 1 to instruct the electronic device 1 to end the performance measurement. This causes the electronic device 1 to return to the time display mode.

Thereafter, the user connects the electronic device 1 to the information terminal 2 (described later) such as a smartphone, a tablet PC (PC: personal computer), and a desktop PC through short-range wireless communication or the like, and thereby transferring log data (user performance data), user body data, user target data, and the like accumulated in the electronic device 1 to the information terminal 2.

Further, the user connects the information terminal 2 to the server 4 (described later) through the network 3 (described later) such as the Internet, thereby uploading the user performance data, the user body data, the user target data, and the like to the server 4 and storing the uploaded data in the server 4.

Further, the user connects the information terminal 2 to the server 4 through the network 3 such as the Internet at a desired timing, thereby confirming his or her user performance data and the like at the information terminal 2. In addition, the user connects the information terminal 2 to the server 4 through the network 3 such as the Internet at a desired timing, and can receive various types of accompanying information (such as an application software program, map data relating to a travel course of the user, terrain data, and weather data) from the server 4.

In addition, it is assumed that the user connects the information terminal 2 in advance to the server 4 through the network 3 such as the Internet and transmits registration information such as identification information (ID) of the electronic device 1, identification information (ID) of the user, to the server 4, thereby completing user registration to the server 4. After registration, the user is able to receive a service for storing user performance data and the above-mentioned accompanying information (an application software program, map data, terrain data, weather data, or the like) provided from the server 4.

### 1-3. Configuration of Electronic Device

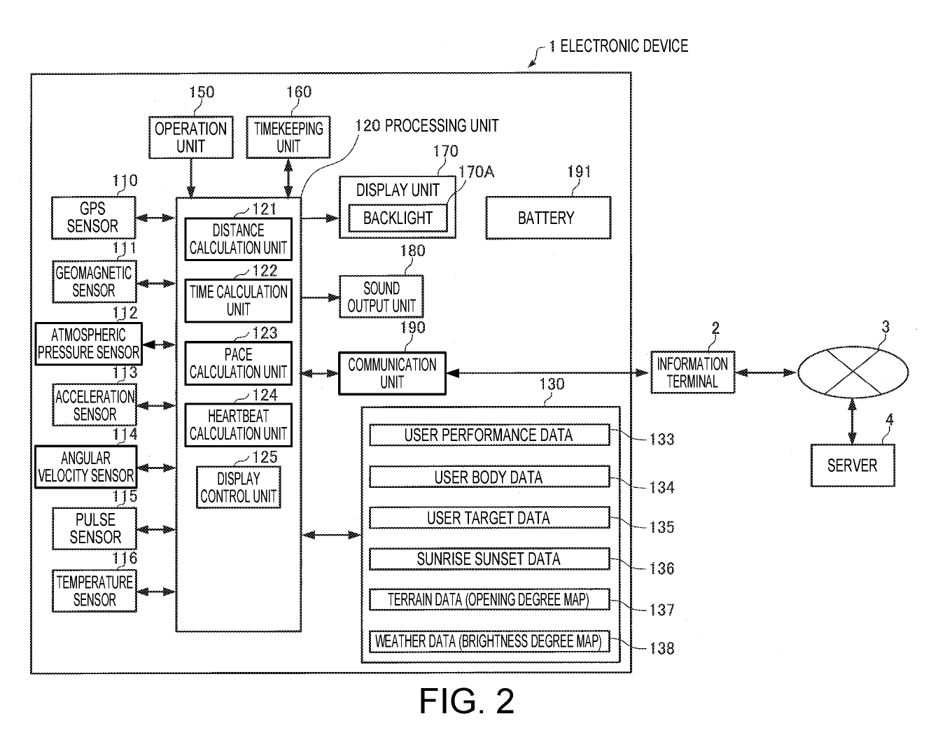

FIG. 2 is a functional block diagram for explaining a configuration of a system including the electronic device of the first embodiment.

The system of the present embodiment includes the electronic device 1, an information terminal 2, and a server 4, and the information terminal 2 and the server 4 are connected through a network 3 such as the Internet. Further, the electronic device 1 and the information terminal 2 can communicate through, for example, short-range wireless communication or the like.

As illustrated in FIG. 2, the electronic device 1 is configured to include a GPS sensor 110, a geomagnetic sensor 111, an atmospheric pressure sensor 112, an acceleration sensor 113, an angular velocity sensor 114, a pulse sensor 115, a temperature sensor 116, a processing unit 120, a storage unit 130, an operation unit 150, a timekeeping unit 160 (an example of a sensor), a display unit 170, a sound output unit 180, a communication unit 190, a battery 191, and the like. However, the electronic device 1 may be configured by deleting or changing some of these constituent elements or by adding other constituent elements (for example, a humidity sensor, an ultraviolet ray sensor, or the like).

The GPS sensor 110 is used for generating positioning data (data such as latitude, longitude, altitude, and speed vector) indicating the position of the electronic device 1 and outputting the data to the processing unit 120, and is configured to include, for example, a GPS receiver (GPS: Global Positioning System), and the like. The GPS sensor 110 receives electromagnetic waves of a predetermined frequency bandwidth coming from the outside with a GPS antenna not illustrated, extracts the GPS signal from the GPS satellite and generates positioning data indicating the position of the electronic device 1 or the like based on the GPS signal.

The geomagnetic sensor 111 is used for detecting the geomagnetic vector indicating the direction of the magnetic field of the earth as seen from the electronic device 1, and generates geomagnetic data indicating, for example, magnetic flux densities in three axis directions which are orthogonal to each other. For the geomagnetic sensor 111, for example, a magnet resistive (MR) element, a magnet impedance (MI) element, a Hall element and the like are used.

The atmospheric pressure sensor 112 is a sensor for detecting ambient pressure (atmospheric pressure), and includes a pressure sensitive element of a type (vibration type) utilizing the change of the resonance frequency of the vibration piece. This pressure sensitive element is, for example, a piezoelectric vibrator made of a piezoelectric material such as quartz, lithium niobate, and lithium tantalate. For example, a tuning fork type vibrator, a double tuning fork type vibrator, an AT vibrator (thickness shear vibrator), SAW resonator, or the like are applied thereto. In addition, the output of the atmospheric pressure sensor 112 may be used to correct positioning data.

The acceleration sensor 113 is an inertial sensor that detects acceleration in three axial directions intersecting each other (ideally orthogonal to each other), and outputs digital signals (acceleration data) according to the magnitudes and directions of the detected three axial acceleration. In addition, the output of the acceleration sensor 113 may be used to correct information on the position included in the positioning data of the GPS sensor 110.

The angular velocity sensor 114 is an inertial sensor that detects angular velocity in three axial directions intersecting each other (ideally orthogonal to each other), and outputs digital signals (angular velocity data) according to the magnitudes and directions of the measured three axial angular velocity. In addition, the output of the angular velocity sensor 114 may be used to correct information on the position included in the positioning data of the GPS sensor 110.

The pulse sensor 115 is a sensor for generating a signal indicating the pulse of the user and outputting the signal to the processing unit 120, and includes, for example, a light source such as an LED light source (LED: Light Emitting Diode) for irradiating measurement light having an appropriate wavelength toward a subcutaneous blood vessel, and a light receiving element for detecting a change in intensity of light generated in a blood vessel according to the measurement light. It is possible to measure the pulse rate (pulse rate per minute) by processing the light intensity change waveform (pulse wave) by a known method such as frequency analysis. As the pulse sensor 115, instead of the photoelectric sensor including the light source and the light receiving element, an ultrasonic sensor for measuring the pulse rate by detecting the contraction of the blood vessel by ultrasonic waves may be adopted, and a sensor that measures the pulse rate by flowing a weak current from the electrode into the body may be adopted.

The temperature sensor 116 is a temperature sensitive element that outputs a signal (for example, a voltage corresponding to temperature) corresponding to the surrounding temperature. In addition, the temperature sensor 116 may output a digital signal corresponding to the temperature.

The processing unit 120 (processor, computer) is configured with, for example, a Micro Processing Unit (MPU), a Digital Signal Processor (DSP), an Application Specific Integrated Circuit (ASIC), and the like. The processing unit 120 executes various processes according to the program stored in the storage unit 130 and various commands input by the user through the operation unit 150. The process by the processing unit 120 includes data processes on the data generated by the GPS sensor 110, the geomagnetic sensor 111, the atmospheric pressure sensor 112, the acceleration sensor 113, the angular velocity sensor 114, the pulse sensor 115, the temperature sensor 116, and the timekeeping unit 160, a sound output process for outputting sound to the sound output unit 180, a power control process for supplying power from the battery 191 to each part, and the like.

In addition, the processing unit 120 appropriately functions as a distance calculation unit 121, a time calculation unit 122, a pace calculation unit 123, a heartbeat calculation unit 124, and a display control unit 125. Details of the distance calculation unit 121, the time calculation unit 122, the pace calculation unit 123, the heartbeat calculation unit 124, and the display control unit 125 will be described later.

The storage unit 130 is configured with, for example, a single or a plurality of IC memories (IC: Integrated Circuit) and the like, and includes a ROM storing data such as a program and a RAM serving as a working area of the processing unit 120. Incidentally, the RAM also includes a nonvolatile RAM, and a storage area for user performance data 133, user body data 134, user target data 135, sunrise sunset data 136, terrain data (opening degree map) 137, weather data (brightness degree map) 138 or the like is secured in the nonvolatile RAM. Since the terrain data (opening degree map) 137 and the weather data (brightness degree map) 138 among such data need to be updated in a case where the use area and the use time of electronic device 1 change, for example, the terrain data 137 and the weather data 138 are provided from the server 4 at an appropriate timing, for example, through the network 3 and the information terminal 2. Since the sunrise sunset data 136 does not need to be updated, the sunrise sunset data 136 is stored, for example, in a nonvolatile RAM in advance.

The operation unit 150 is configured with, for example, a button, a key, a microphone, a touch panel, a voice recognition function (using a microphone not illustrated), an action detection function (using an acceleration sensor 113 and the like) or the like, and executes a process of converting an instruction from the user into an appropriate signal and sending the signal to the processing unit 120. The above-mentioned operation buttons 150B, 150A, 150C, and 150D are at least a part of the operation unit 150.

The timekeeping unit 160 is configured with, for example, a real time clock (RTC) IC, or the like, generates time data such as year, month, day, hour, minute, second (an example of information generated based on the output of a sensor), and sends time data to the processing unit 120. In addition, the time data may be appropriately corrected based on the time information included in the positioning data.

The display unit 170 is configured with, for example, a liquid crystal display (LCD), an organic electroluminescence (EL) display, an electrophoretic display (EPD), a touch panel display, and the like, and displays various images in accordance with an instruction from the processing unit 120. The display unit 170 is provided with a backlight 170A (an example of lighting of a display unit) to be described later. In a case where the display unit 170 is a reflective display, the backlight of the display unit 170 is, for example, a front light type backlight. Further, in a case where the display unit 170 is a self-emissive display, a brightness adjustment function of the display itself (an example of lighting of the display unit) is referred to as the “backlight 170A”.

The sound output unit 180 is configured with, for example, a speaker, a buzzer, a vibrator, or the like, and generates various sounds (or vibration) in accordance with an instruction from the processing unit 120.

The communication unit 190 executes various controls for establishing data communication between the electronic device 1 and the information terminal 2. The communication unit 190 is configured to include, for example, a transceiver compatible with the short range wireless communication standard such as Bluetooth (registered trademark) (including BTLE: Bluetooth Low Energy), Wi-Fi (registered trademark) (Wi-Fi: Wireless Fidelity), Zigbee (registered trademark), Near field communication (NFC), and ANT+ (registered trademark).

The battery 191 is, for example, a rechargeable battery that supplies power to each element constituting the electronic device 1. As a charging method of the battery 191, for example, non-contact charging, contact charging (charging using a cradle or the like), and the like can be applied. In the present embodiment, a case is assumed where it is difficult to charge the battery 191 in the outside destination and there is a high necessity of reducing the power consumption of the electronic device 1. The battery 191 maybe a replaceable type battery.

The information terminal 2 is an information terminal such as a smartphone, a tablet PC (PC: personal computer), and a desktop PC which are connectable to the network 3 such as the Internet, and is provided with a communication unit not illustrated compatible with the communication unit 190 of the electronic device 1. A program for controlling the electronic device 1 and the like are installed in the storage unit (not illustrated) of the information terminal 2, and when the information terminal 2 is connected to at least the electronic device 1, the information terminal 2 operates according to this program. For example, this program is downloaded from the server 4 through the network 3 such as the Internet.

The server 4 is a server connected to the network 3 such as the Internet. The server 4 has a function of managing data uploaded from the user of the electronic device 1 for each user. Further, the server 4 has a function of providing programs, map data, terrain data (opening degree map), weather data (brightness degree map), or the like, to the user of the electronic device 1.

### 1-4. Details of Processing Unit

Hereinafter, the distance calculation unit 121, the time calculation unit 122, the pace calculation unit 123, and the heartbeat calculation unit 124 in the processing unit 120 will be described in order. In addition, the combination of sensors used for generating the user performance data is an example, and any known combination can be adopted in the calculation of the user performance data.

The distance calculation unit 121 calculates the cumulative travel distance of the user within the period from the start time of the travel course to the current time, for example, based on the output of the timekeeping unit 160 and the output of the GPS sensor 110.

In a case where “a lap section of a time” is set as the lap section, the distance calculation unit 121 calculates the moving distance of the user within the period from the start time to the end time of the lap section as the lap distance of the lap section, based on the output of the timekeeping unit 160 and the output of the GPS sensor 110.

In addition, the cumulative travel distance and the lap distance calculated by the distance calculation unit 121 are written to the user performance data 133 of the storage unit 130.

Further, the distance calculation unit 121 uses at least one of the output of the acceleration sensor 113, the output of the angular velocity sensor 114, the output of the user body data 134, the output of the geomagnetic sensor 111, and the output of the atmospheric pressure sensor 112, thereby improving the accuracy of distance calculation.

The time calculation unit 122 calculates the elapsed time from the start time of the travel course to the current time as the split time of the user, for example, based on the output of the timekeeping unit 160.

In a case where “a lap section of a distance” is set as the lap section, the time calculation unit 122 calculates the moving time of the user in a route from the start point to the end point of the lap section as the lap time of the lap section, based on the output of the timekeeping unit 160 and the output of the GPS sensor 110.

In addition, the split time and the lap time calculated by the distance calculation unit 121 are written to the user performance data 133 of the storage unit 130.

Further, the time calculation unit 122 uses at least one of the output of the acceleration sensor 113, the output of the angular velocity sensor 114, the output of the user body data 134, the output of the geomagnetic sensor 111, and the output of the atmospheric pressure sensor 112, thereby improving the accuracy of time calculation.

The pace calculation unit 123 calculates, for example, the average traveling speed of the user from the start point of the travel course to the current point as the average pace of the user, based on the output of the timekeeping unit 160 and the output of the GPS sensor 110.

In a case where “a lap section of a time” is set as the lap section, the pace calculation unit 123 calculates the average traveling speed of the user within a period from the start time to the end time of the lap section as the lap pace, based on the output of the timekeeping unit 160 and the output of the GPS sensor 110.

In a case where “a lap section of a distance” is set as the lap section, the pace calculation unit 123 calculates the average traveling speed of the user in the route from the start point to the endpoint of the lap section as the lap pace, based on the output of the timekeeping unit 160 and the output of the GPS sensor 110.

The heartbeat calculation unit 124 calculates, for example, the average heart rate per unit time of the user from the start time of the travel course to the current time, based on the output of the timekeeping unit 160 and the output of the pulse sensor 115.

In a case where “a lap section of a time” is set as the lap section, the heartbeat calculation unit 124 calculates the average heart rate of the user within a period from the start time to the end time of the lap section as the lap heart rate, based on the output of the timekeeping unit 160 and the output of the pulse sensor 115.

In a case where “a lap section of a distance” is set as the lap section, the heartbeat calculation unit 124 calculates the average heart rate of the user in the route from the start point to the end point of the lap section as the lap heart rate, based on the output of the timekeeping unit 160 and the output of the pulse sensor 115.

Further, the display control unit 125 performs a display process for displaying an image on the display unit 170. In addition, the display control unit 125 controls the power supplied to the backlight 170A (described later) provided in the display unit 170, and executes a process of adjusting the lighting illuminance (lighting brightness) of the backlight 170A, a process of controlling the lighting timing of the backlight 170A, a process of controlling the turning-off timing of the backlight 170A, and the like. The details of the backlight 170A will be described later.

### 1-5. Process of Information Terminal

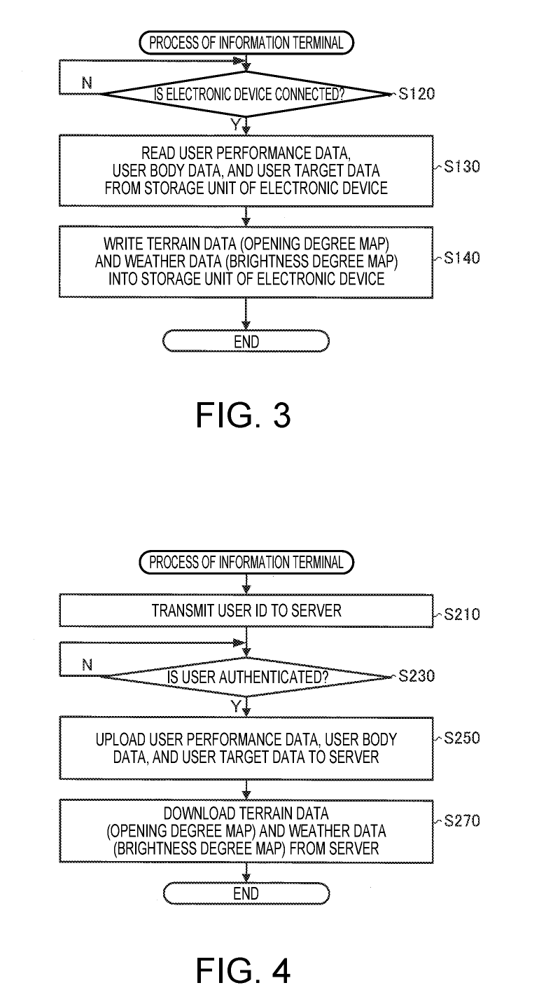

FIG. 3 is a flowchart for explaining a process of the information terminal 2 relating to data transfer with the electronic device 1. Each step of FIG. 3 will be explained in order below.

First, the information terminal 2 determines whether communication with the electronic device 1 is possible through short-range wireless communication (S120). In a case where it is determined that it is possible (Y at S120), the next process is started (S130), and if not (N at S120), a process is waited for.

Next, the information terminal 2 accesses the storage unit 130 of the electronic device 1 through the communication unit 190 and the processing unit 120 of the electronic device 1, and reads the user performance data 133, the user body data 134, and the user target data 135, stored in the storage unit 130 (S130).

Next, the information terminal 2 accesses the storage unit 130 of the electronic device 1 through the communication unit 190 and the processing unit 120 of the electronic device 1, writes the terrain data (opening degree map) and the weather data (brightness degree map) downloaded from the server 4 into the storage unit 130, and ends the flow (S140). The downloading step will be described later.

Transmission of data (data transfer) between the electronic device 1 and the information terminal 2 is performed in a predetermined format.

FIG. 4 is a flowchart for explaining a process of the information terminal 2 relating to information communication with a server 4. Each step of FIG. 4 will be explained in order below.

First, the information terminal 2 transmits the user ID to the server 4 through the network 3 (S210).

Next, the information terminal 2 determines whether or not an access permission notification has been received from the server 4 through the network 3 (S230). In a case where it is determined that the access has been received (in a case where the user authentication is completed) (Y at S230), the next process (S250) is started, and if not (N at 5230), a process is waited for.

Next, the information terminal 2 transmits to the server 4, the user performance data 133, the user body data 134, and the user target data 135, read from the electronic device 1 (S250).

Next, the information terminal 2 downloads the terrain data (opening degree map) and the weather data (brightness degree map) of the area designated by the user from the server 4 through the network 3 and ends the flow (S270). The area is an area including the aforementioned travel course.

Transmission of data (information communication) between the information terminal 2 and the server 4 is performed in a predetermined format.

### 1-6. Regarding Backlight

The display unit 170 of the present embodiment is equipped with a backlight 170A. The backlight 170A is a lighting device provided for enhancing the visibility of information displayed on the display unit 170. The control of the backlight 170A is executed by the display control unit 125 (processing unit 120).

For example, in a case where the display unit 170 is configured with a liquid crystal display (LCD), the backlight 170A of the display unit 170 is a lighting device provided on the back surface or the side surface of the liquid crystal panel of the LCD, a lighting device provided on the side surface of the liquid crystal panel, or the like.

If the backlight 170A of the display unit 170 is lit, the brightness (that is, the amount of transmitted lighting light or the amount of reflected lighting light) of a portion having a relatively high brightness is increased in the image (for example, a monochrome image) displayed on the display unit 170, such that the contrast of the image is increased, and as a result, the visibility (visibility in a dark environment) of the image is enhanced. The light source used for the backlight 170A is, for example, a white LED light source (LED: Light Emitting Diode) or an LED light source of another color. Hereinafter, the amount of lighting light by the backlight 170A is referred to as “lighting illuminance of the backlight 170A”, or “lighting brightness of the backlight 170A”.

Basically, the processing unit 120 restricts the lighting of the backlight 170A of the display unit 170 to a period when the user inputs a light turning-on instruction, and turns off the backlight 170A during the period when the user does not input the light turning-on instruction. Alternatively, lighting is limited to within a predetermined time (for example, within 3 seconds, within 10 seconds, or the like) from the input of the light turning-on instruction. However, when the automatic notification function from the electronic device 1 to the user (an automatic lap function to be described later is also a type of the automatic notification function) is turned on, the backlight 170A may be temporarily turned on at the notification timing. On the other hand, in the case where the night mode function (described later) is developed in the electronic device 1 (in a case where the processing unit 120 is operating in the night mode), even at the notification timing, in the case of the daytime period (a period from sunrise to sunset), the lighting of the backlight 170A is prohibited.

Here, in principle, the word “lighting the backlight 170A” is used as meaning of “a state where the power is supplied from the battery 191 to the backlight 170A and the backlight 170A lights the display screen of the display unit 170 in a predetermined illuminance. However, “lighting the backlight 170A” may include not only the case where the lighting illuminance of the backlight 170A is stationary but also the case where the lighting illuminance of the backlight 170A changes periodically (a case of blinking at high speed and where the lighting illuminance is regarded as stationary for the user).

Here, in principle, the word “turning off the backlight 170A” is used as meaning of “a state where the power supplied from the battery 191 to the backlight 170A is decreased and the backlight 170A does not light the display screen of the display unit 170. However, “turning off the backlight 170A” may include not only the case where the lighting illuminance of the backlight 170A is completely zero but also the case where the lighting illuminance of the backlight 170A is lower than the lighting illuminance when the backlight 170A is lit.

### 1-7. Night Mode Function

As described above, basically, turning on the backlight 170A of the display unit 170 is limited to during a period when the user inputs a light turning-on instruction, and the backlight 170A is turned off during the period when the user does not input the light turning-on instruction. However, when the automatic notification function from the electronic device 1 to the user (here, an automatic lap function is assumed) is turned on, the backlight 170A is temporarily (for example, for two seconds) lit at the notification timing (separation of a lap section).

However, in a case where the night mode function is developed in the electronic device 1, even at the notification timing (separation of a lap section), as long as the timing is a daytime period (a period from sunrise to sunset), the lighting of the backlight 170A is prohibited.

In other words, in the night mode function, a period during which the lighting of the backlight 170A is permitted (lighting permission period) and a period during which the lighting of the backlight 170A is prohibited (a lighting prohibited period and a period during which the backlight 170A is turned off) are provided in the electronic device 1, the lighting permission period corresponds to night time (a period from sunset to sunrise), and the lighting prohibited period corresponds to the daytime (period from sunrise to sunset). Further, the lighting prohibited period by the night mode function may be deviated from the daytime by a minute time (for example, several minutes). Further, the lighting permission period by the night mode function may be deviated from the night by a minute time (for example, several minutes). However, this minute time is a predetermined time (fixed value). Therefore, this deviation is different from the deviation caused by the adjustment (described later) of the present embodiment.

The lighting frequency or lighting brightness of the backlight 170A during the lighting permission period is set higher than the lighting frequency or lighting brightness of the backlight 170A in the lighting prohibited period. That is, the night mode can be said to be a mode that improves the lighting frequency or the lighting brightness of the lighting during the period from sunset to sunrise than the lighting frequency or the lighting brightness of the lighting during the period from sunrise to sunset.

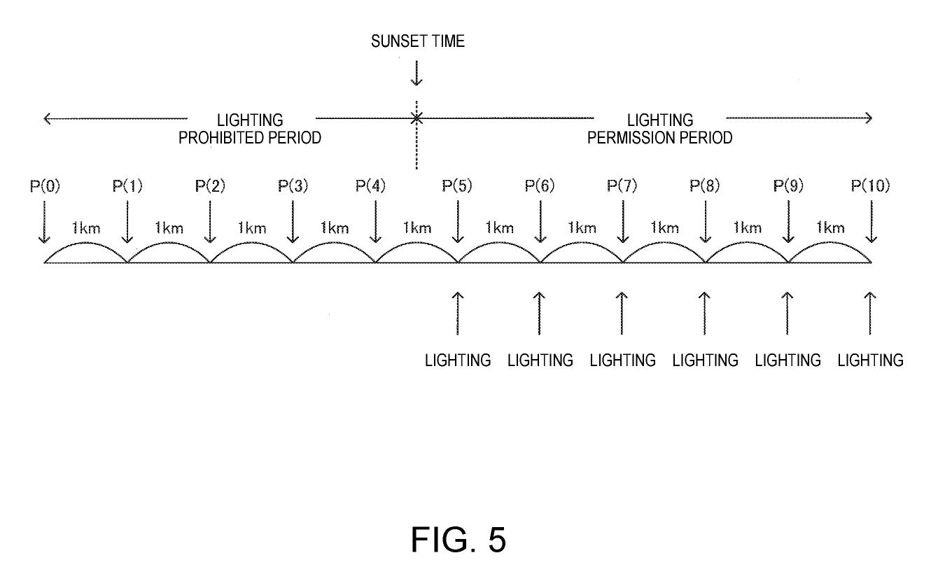

FIG. 5 illustrates each timing in a case where the function of the night mode and the automatic lap function are developed in the electronic device 1. The horizontal axis in FIG. 5 is a distance.

FIG. 5 illustrates a case where the lap section is set to a section of 1 km, and the user is notified of the lap information of the latest lap section (a lap time, a lap pace, a lap heart rate, target achievement thereof, and the like) every time the user arrives at the separation points P(0) to P(10) of the lap sections.

Assuming that the timing at which the user arrives at the middle point between the points P(4) and P(5) out of the separation points P(0) to P(10) is sunset time, the backlight 170A is not lit in the points P(0) to P(4) that the user reaches before the sunset time, and the backlight 170A is lit in the points P(5) to P(10) that the user reaches after the sunset time.

Here, the sunrise time and the sunset time vary depending on the date to which the current time (current point of time) belongs (here, “date” is used in the meaning of year, month, and day of the current day) and the current position (current point). Thus, the processing unit 120 of the electronic deice 1 calculates the sunrise time and sunset time of the date to which the current time belongs, based on the current position included in the positioning data (an example of information generated based on the output of a sensor and input information), the current time included in the time data (an example of information generated based on the output of a sensor and input information), and the sunrise sunset data 136.

The sunrise sunset data 136 is data indicating the relationship between the current time and the current position and the sunrise time and sunset time, and is configured with a table, a calculation equation, or a combination thereof. Since the content of the calculation (astronomical calculation) for calculating the sunrise time and the sunset time from the current time and the current position is well known, a detailed explanation of the sunrise sunset data 136 is omitted here.

The sunrise sunset data 136 is written into, for example, the storage unit 130 of the electronic device 1 in advance. However, the sunrise sunset data 136 may be provided from the server 4 together with terrain data (opening degree map) and the like. Since the sunrise sunset data 136 basically does not need to be rewritten, in the case where the sunrise sunset data 136 is written into the storage unit 130 in advance, the write destination in the storage unit 130 may be a ROM in addition to a nonvolatile RAM.

Here, it is assumed that the sunrise sunset data 136 used in the present embodiment is data prepared on the premise that the current position is a flat open place. That is, the sunrise time calculated based on the sunrise sunset data 136 is the “a time of sunrise seen from the user who is at an open place of zero meter above sea level”, and the sunset time calculated based on the sunrise sunset data 136 is “a time of sunset seen from the user who is at an open place of zero meter above sea level”. In other words, the sunrise sunset data 136 is the data of the sunrise sunset time for which the peripheral terrain of a place of zero meter above sea level in the latitude and longitude of the current position is not considered.

Hereinafter, the sunrise time calculated based on the sunrise sunset data 136 is referred to as “standard sunrise time”, the sunset time calculated based on the sunrise sunset data 136 is referred to as “standard sunset time”, the lighting permission period set in the period from the standard sunset time to the standard sunrise time is referred to as “standard lighting permission period”, the start time of the standard lighting permission period is referred to as “standard start time”, and the end time of the standard lighting permission period is referred to as “standard end time”.

### 1-8. Adjustment of Night Mode Function

The necessity of adjustment of the night mode function will be described below. The lighting permission period of the night mode function needs to be adjusted as appropriate due to the following reasons.

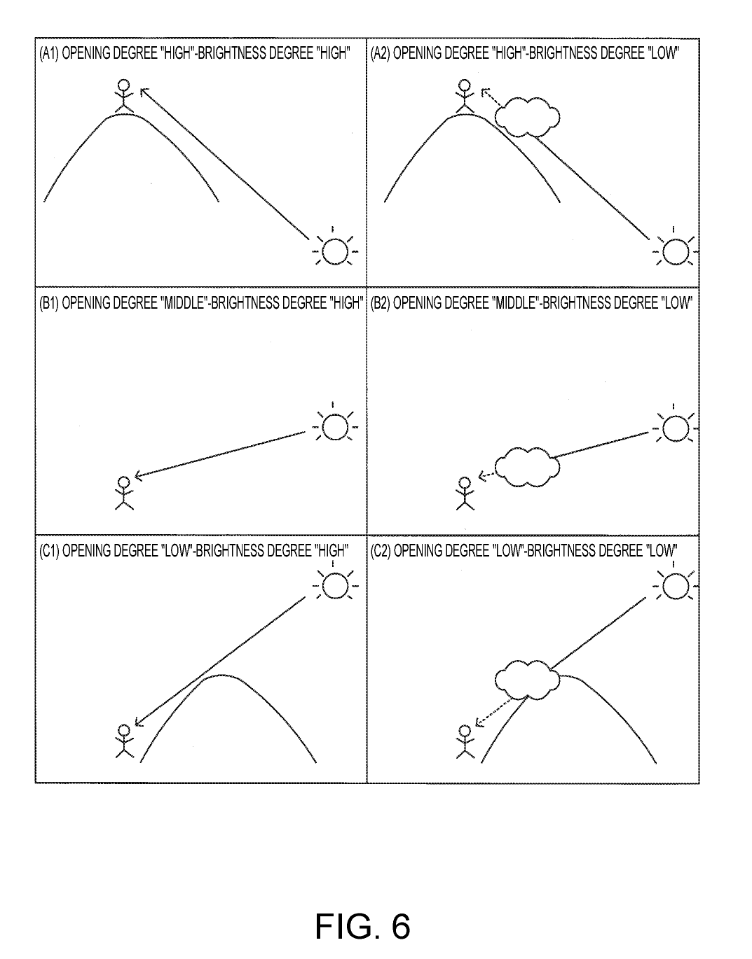

FIG. 6 is a diagram for explaining the relationship between environment where a user is located and how the sun looks.

First, as illustrated in FIG. 6 (A1), when the user is at the summit, the horizon far from the ground surface (the foot of the mountain) can be seen, such that the actual sunrise time is earlier than the standard sunrise time, and the actual sunset time is later than the standard sunset time.

Therefore, for a user placed in such an environment, it is desirable that the end time of the lighting permission period is set to be earlier than the standard end time, and it is desirable that the start time of the lighting permission period is set to be later than the standard start time.

Next, as illustrated in FIG. 6(B1), when the user is in an open place (near zero meter above sea level), the actual sunrise time matches the standard sunrise time and the actual sunset time matches the standard sunset time.

Therefore, for a user placed in such an environment, it is desirable that the end time of the lighting permission period is set to be the same as the standard end time, and it is desirable that the start time of the lighting permission period is set to be the same as the standard start time.

Next, as illustrated in FIG. 6 (C1), when the user is in a valley, the horizon cannot be seen, such that the actual sunrise time is delayed from the standard sunrise time, and the actual sunset time is earlier than the standard sunset time.

Therefore, for a user placed in such an environment, it is desirable that the end time of the lighting permission period is set to be later than the standard end time, and it is desirable that the start time of the lighting permission period is set to be earlier than the standard start time.

Furthermore, even when the user is at the summit during the daytime, the brightness in the vicinity of the user is different between the time of clear weather (FIG. 6 (A1)) and the time of cloudy weather (FIG. 6 (A2)). Specifically, the vicinity of the user is darker in the cloudy weather (FIG. 6 (A2)) than in the clear weather (FIG. 6 (A1)). Therefore, it is desirable that the lighting permission period when the user is at the summit is longer in the cloudy weather (FIG. 6 (A2)) than in the clear weather (FIG. 6 (A1)).

Even when the user is in an open place during the daytime, the brightness in the vicinity of the user is different between clear weather (FIG. 6 (B1)) and cloudy weather (FIG. 6 (B2)). Specifically, the vicinity of the user is darker in the cloudy weather (FIG. 6 (B2)) than in the clear weather (FIG. (B1)). Therefore, it is desirable that the lighting permission period when the user is located at an open place is longer in the cloudy weather (FIG. 6 (B2)) than in the clear weather (FIG. 6 (B1)).

Even when the user is in the valley during the daytime, the brightness in the vicinity of the user is different between clear weather (FIG. 6 (C1)) and cloudy weather (FIG. 6 (C2)). Specifically, the vicinity of the user is darker in the cloudy weather (FIG. 6 (C2)) than in the clear weather (FIG. 6 (C1)). Therefore, it is desirable that the lighting permission period when the user is in the valley is longer in the cloudy weather (FIG. 6 (C2)) than in the clear weather (FIG. 6 (C1)).

### 1-9. Manual Adjustment of Night Mode

Thus, the processing unit 120 of the electronic device 1 of the present embodiment allows the user to manually adjust the lighting permission period in the night mode. Hereinafter, the lighting permission period before adjustment is referred to as “standard lighting permission period”, the lighting permission period after adjustment is appropriately referred to as “lighting permission period after adjustment” or “lighting permission period”, the start time of the lighting permission period after adjustment is referred to as “start time”, and the end time of the lighting permission period after adjustment is referred to as “end time”.

For example, the processing unit 120 basically sets the lighting permission period to be the same as the standard lighting permission period, and in a case where there is an instruction from the user, at least one of the start time and the end time of the lighting permission period Is adjusted by at least one of the following adjustment methods (1) to (7), for example, and the adjusted lighting permission period is used for an actual operation (such as auto notification). The adjusted lighting permission period is used basically when the automatic adjustment function of the night mode is turned off or when the automatic adjustment function of the night mode is not installed in the electronic device 1 (however, it is also possible to configure the electronic device 1 in which the manual adjustment function of the night mode is developed in preference to the automatic adjustment function of the night mode).

### 1. Length Adjustment of Lighting Permission Period

The processing unit 120 of the electronic device 1 allows the user to designate whether to adjust the standard lighting permission period to “long” or “short” (an example of information input by the user). The designation is performed on, for example, the menu screen. The designation by the user is performed through the operation unit 150.

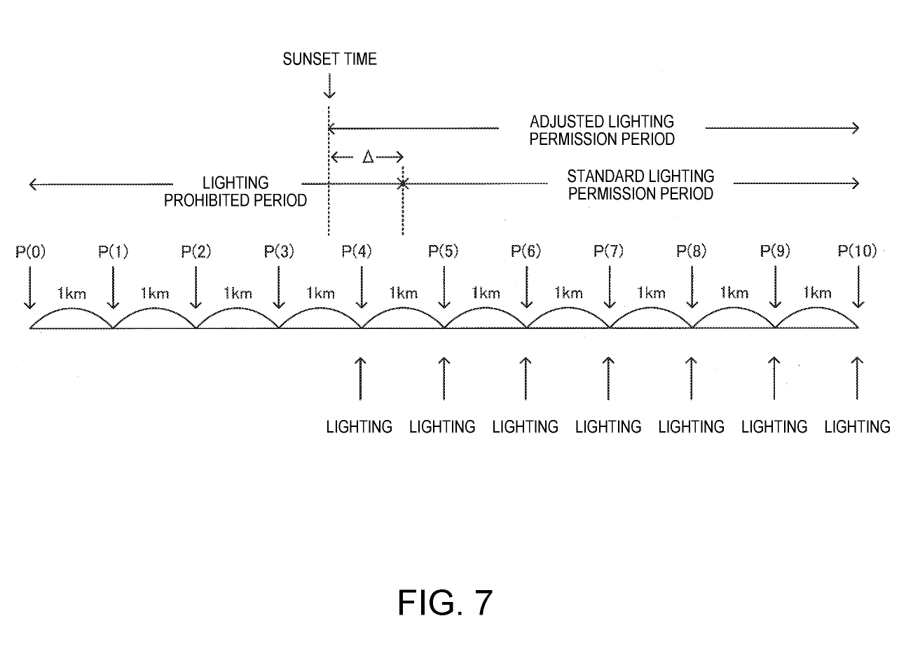

In a case where the user designates “long”, the processing unit 120 adjusts the start time of the lighting permission period to a time earlier than the standard start time by a predetermined adjustment amount Δ, and sets the end time of the lighting permission period to a time later than the standard end time by a predetermined adjustment amount Δ (see the symbol Δ in FIG. 7).

On the other hand, in a case where the user designates “short”, the processing unit 120 adjusts the start time of the lighting permission period to a time later than the standard start time by a predetermined adjustment amount Δ, and sets the end time of the lighting permission period after adjustment to a time earlier than the standard end time by a predetermined adjustment amount Δ.

Here, although the adjustment amount Δ is assumed to be a positive value, there may be a “do not change” option, and in the case of “do not change”, the adjustment amount Δ may be zero. Further, a negative value may be included in the adjustment amount Δ, or different values may be used for the start time and the end time.

### 2. Adjustment of Lighting Start Time

The processing unit 120 of the electronic device 1 allows the user to designate whether to set the start time of the lighting permission period to “early” or “late” (an example of input information input by the user). The designation is performed on, for example, the menu screen. The designation by the user is performed through the operation unit 150.

In a case where the user designates “early”, the processing unit 120 adjusts the start time of the lighting permission period to a time earlier than the standard start time by a predetermined adjustment amount Δ.

On the other hand, in a case where the user designates “late”, the processing unit 120 adjusts the start time of the lighting permission period to a time later than the standard start time by a predetermined adjustment amount Δ.

Note that the adjustment method (2) is preferably adopted together with the adjustment method (3).

Here, although the adjustment amount Δ is assumed to be a positive value, there may be a “do not change” option, and in the case of “do not change”, the adjustment amount Δ may be zero. Further, a negative value may be included in the adjustment amount Δ, or different values may be used for the start time and the end time.

### 3. Adjustment of Lighting End Time

The processing unit 120 of the electronic device 1 allows the user to designate whether to set the end time of the lighting permission period to “early” or “late” than the standard end time (an example of input information input by the user). The designation is performed on, for example, the menu screen. The designation by the user is performed through the operation unit 150.

In a case where the user designates “early”, the processing unit 120 adjusts the end time of the lighting permission period to a time earlier than the standard end time by a predetermined adjustment amount Δ.

On the other hand, in a case where the user designates “late”, the processing unit 120 adjusts the end time of the lighting permission period to a time later than the standard end time by a predetermined adjustment amount Δ.

Note that the adjustment method (3) is desirably adopted together with the adjustment method (2).

Here, although the adjustment amount Δ is assumed to be a positive value, there may be a “do not change” option, and in the case of “do not change”, the adjustment amount Δ may be zero. Further, a negative value may be included in the adjustment amount Δ, or different values may be used for the start time and the end time.

### 4. Numerical Input

The processing unit 120 of the electronic device 1 enables the user to input the value of the adjustment amount in any one of the adjustment method (1), the adjustment method (2), and the adjustment method (3). This adjustment amount (an example of input information input from the user) is input on for example, the menu screen. In addition, the input by the user is performed through the operation unit 150.

For example, in the adjustment method (1), in a case where the user inputs “+1 hour”, the processing unit 120 adjusts the start time of the lighting permission period to time earlier than the standard start time by one hour, and adjusts the end time of the lighting permission period to time later than the standard end time by one hour.

For example, in the adjustment method (1), in a case where the user inputs “−1 hour”, the processing unit 120 adjusts the start time of the lighting permission period to time later than the standard start time by one hour, and adjusts the end time of the lighting permission period to time earlier than the standard end time by one hour.

For example, in the adjustment method (2), in a case where the user inputs “+1 hour”, the processing unit 120 adjusts the start time of the lighting permission period to a time earlier than the standard start time by one hour.

For example, in the adjustment method (2), in a case where the user inputs “−1 hour”, the processing unit 120 adjusts the start time of the lighting permission period to a time later than the standard start time by one hour.

For example, in the adjustment method (3), in a case where the user inputs “+1 hour”, the processing unit 120 adjusts the end time of the lighting permission period to a time later than the standard end time by one hour.

For example, in the adjustment method (3), in a case where the user inputs “−1 hour”, the processing unit 120 adjusts the end time of the lighting permission period to a time earlier than the standard end time by one hour.

### 5. Environment Input (Terrain)

The processing unit 120 of the electronic device 1 allows the user to designate whether the environment in which the electronic device 1 is used is “open place” or “not-open place” (an example of input information input by the user, information on environment where the user is located, and information on terrain). The designation is performed on, for example, the menu screen. The designation by the user is performed through the operation unit 150.

Ina case where the user designates “not-open place”, the processing unit 120 adjusts the start time of the lighting permission period to a time earlier than the standard start time by a predetermined adjustment amount Δ, and sets the end time of the lighting permission period to a time later than the standard end time by a predetermined adjustment amount Δ.

On the other hand, in a case where the user designates “open place”, the processing unit 120 adjusts the start time of the lighting permission period to a time later than the standard start time by a predetermined adjustment amount Δ, and sets the end time of the lighting permission period to a time earlier than the standard end time by a predetermined adjustment amount Δ.

Here, the items of the environment that can be designated by the user are set as “open place” and “not-open place”, but in addition, any one of “building city”, “open”, “valley”, “summit”, “ridge line”, “coast”, “surrounded by mountains”, “not surrounded by mountains”, “near the summit of altitude of 1000 m or more”, and the like may be added or any combination thereof may be used. At least, it is desirable that the item of the environment that can be designated by the user is an item necessary for estimating the deviation between the actual sunrise time and the standard sunrise time, and the deviation between the actual sunset time and the standard sunset time.

Here, although the adjustment amount Δ is assumed to be a positive value, there may be a “do not change” option, and in the case of “do not change”, the adjustment amount Δ may be zero. Further, a negative value may be included in the adjustment amount Δ, or different values may be used for the start time and the end time.

### 6. Environment Input (Weather)

The processing unit 120 of the electronic device 1 allows the user to designate whether the environment in which the electronic device 1 is used is “clear weather” or “cloudy weather” (an example of input information input from the user, information on environment where a user is located, and information on weather). The designation is performed on, for example, the menu screen. The designation by the user is performed through the operation unit 150.

Ina case where the user designates “cloudy weather”, the processing unit 120 adjusts the start time of the lighting permission period to a time earlier than the standard start time by a predetermined adjustment amount Δ, and sets the end time of the lighting permission period to a time later than the standard end time by a predetermined adjustment amount Δ.

On the other hand, in a case where the user designates “clear weather”, the processing unit 120 adjusts the start time of the lighting permission period to a time later than the standard start time by a predetermined adjustment amount Δ, and sets the end time of the lighting permission period to a time earlier than the standard end time by a predetermined adjustment amount Δ.

Here, the items of the environment that can be designated by the user are set as “clear weather” and “cloudy weather”, but in addition, any one of “rainy weather”, “weak rain”, and the like may be added or other items may be added to the items of the environment that can be designated by the user. At least, it is desirable that the item of the environment that can be designated by the user is an item necessary for estimating the deviation between the actual sunrise time and the standard sunrise time, and the deviation between the actual sunset time and the standard sunset time.

Here, although the adjustment amount Δ is assumed to be a positive value, there may be a “do not change” option, and in the case of “do not change”, the adjustment amount Δ may be zero. Further, a negative value may be included in the adjustment amount Δ, or different values may be used for the start time and the end time.

### 7. Environment Input (Terrain and Weather)

The adjustment method (7) is a combination of the adjustment methods (5) and (6). That is, the processing unit 120 allows the user to designate both an item related to terrain and an item related to weather.

The processing unit 120 sets the adjustment amount Δ by a combination of “the degree of opening” determined by the item related to terrain and “the degree of brightness” determined by the item related to weather.

For example, if the terrain designated by the user is a terrain where the distant horizon is seen, the processing unit 120 regards that the degree of opening is high, and if the weather designated by the user is weather having a long bright time, the processing unit 120 regards that the degree of brightness is high. Then, the processing unit 120 sets the adjustment amount Δ according to the combination of the degree of opening and the degree of brightness. Specifically, the adjustment amount Δ is set to be larger as the degree of opening is lower, and is set to be larger as the degree of brightness is lower.

For example, the processing unit 120 determines the adjustment amount Δ by referring to the calculation table illustrated in FIG. 10 according to the combination of the degree of opening and the degree of brightness, adjusts the start time of the lighting permission period to time earlier than the standard start time by a predetermined adjustment amount Δ, and adjusts the end time of the lighting permission period to time later than the standard end time by a predetermined adjustment amount Δ.

Therefore, in a case where the adjustment amount Δ is a positive value (plus value), the lighting permission period is enlarged, and in a case where the adjustment Δ is a negative value (minus value), the lighting permission period is reduced.

The details of the adjustment using the calculation table (FIG. 10) will be explained in the “Automatic adjustment of the night mode”. In the calculation table (FIG. 10), both the case where the adjustment amount Δ is a positive value and the case where the adjustment amount Δ is a negative value are assumed.

### 1-9. Automatic Adjustment of Night Mode Based on Terrain Data and Weather Data

The automatic adjustment function of the night mode will be described below. This automatic adjustment function automates the aforementioned adjustment method (7).

### 1-9-1. Terrain Data (Opening Degree map)

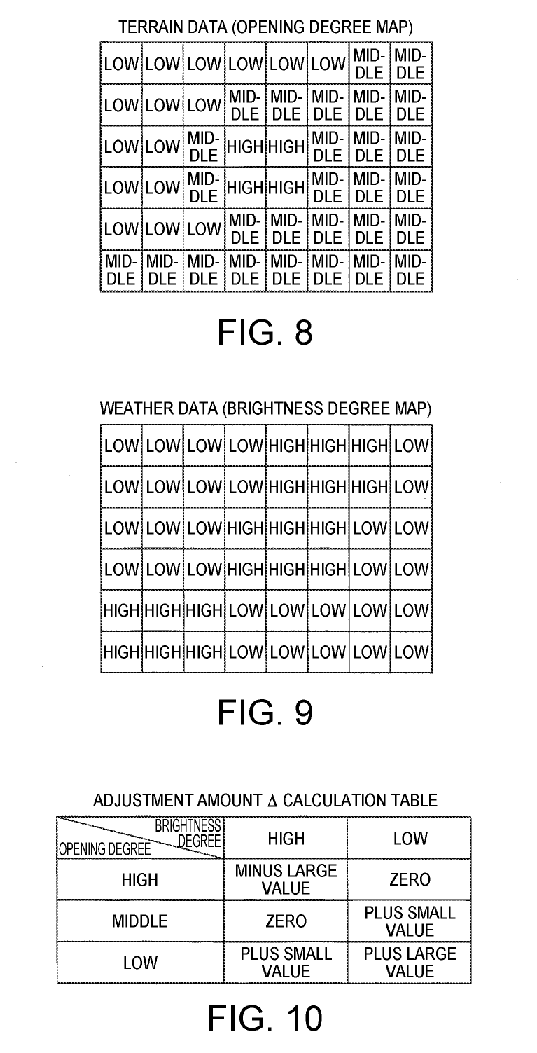

FIG. 8 is a diagram for explaining an example of terrain data (opening degree map) stored in the storage unit 130 (terrain data is an example of received information, information on terrain, and input information). In FIG. 8, for example, the longitudinal direction corresponds to the latitude direction, and the lateral direction corresponds to the longitude direction.

This terrain data (opening degree map) is provided from the server 4 and is a map of an area including the travel course of the user.

As illustrated in FIG. 8, the terrain data (opening degree map) reflects terrain (altitude distribution) of the area. However, it is assumed that the terrain data (opening degree map) of the present embodiment is obtained by transforming the altitude distribution of the area into the distribution of the degree of opening of the area. In other words, “low”, “high”, and “middle” in FIG. 8 do not represent the altitude of each point in the area, but represents the degree of opening of each point in the area.

Note that the conversion from the altitude distribution to the terrain data (opening degree map) may be executed in advance by, for example, the server 4, may be executed by the application ware of the information terminal 2, or may be executed by the processing unit 120. Further, in addition to the altitude, the height of the building or the like may be considered. For example, at the time of conversion, with respect to the degree of opening of each point in the area, the server 4 sets the degree of opening high if the point is an open point, and sets the degree of opening low if the point is not an open point, based on the altitude of the point and an elevation difference from the building (point) existing around the point to the altitude.

Upon recognizing the current position based on the positioning data output from the GPS sensor 110, the processing unit 120 refers to the terrain data (opening degree map) according to the current position to calculate the degree of opening in the current position.

### 1-9-2. Weather Data (Brightness Degree Map)

FIG. 9 is a diagram for explaining an example of weather data (brightness degree map) stored in the storage unit 130 (weather data is an example of received information, information on weather, input information). In FIG. 9, for example, the longitudinal direction corresponds to the latitude direction, and the lateral direction corresponds to the longitude direction.

The terrain data (opening degree map) is provided from the server 4 and is a map of an area including the travel course of the user.

As illustrated in FIG. 9, weather data (brightness degree map) reflects weather (cloud distribution) of the area. However, it is assumed that the weather data (brightness degree map) of the present embodiment is obtained by transforming the distribution of clouds in the area into the distribution of the degree of brightness of the area. In other words, “low”, “high”, and “middle” in FIG. 9 do not represent the thickness of the cloud of each point in the area, but represents the degree of brightness of each point in the area.

Note that the conversion from the distribution of clouds to the weather data (brightness degree map) may be executed in advance by, for example, the server 4, may be executed by the application ware of the information terminal 2, or may be executed by the processing unit 120. For example, at the time of conversion, with respect to the degree of brightness of each point in the area, the server 4 sets the degree of brightness high if the point is a bright point, and sets the degree of brightness low if the point is not a bright point, based on the thickness of the cloud existing at the point, the atmospheric pressure at the point, and the like.

Upon recognizing the current position based on the positioning data output from the GPS sensor 110, the processing unit 120 refers to the weather data (the degree of brightness map) according to the current position to calculate the degree of brightness in the current position.

### 1-9-3. Calculation Table of Adjustment Amount Δ

FIG. 10 is a diagram for explaining an example of a calculation table of an adjustment amount Δ. The calculation table is stored in advance in, for example, the storage unit 130 (not illustrated in FIG. 2).

The calculation table is used for uniquely calculating the above-mentioned adjustment amount Δ from the combination of the degree of opening and the degree of brightness of the current position.

As illustrated in FIG. 10, in this calculation table, each combination of the degree of opening and the degree of brightness is associated with the value of the adjustment amount Δ suitable for the combination. According to this calculation table, as the degree of opening is lower, the adjustment amount Δ is set to a larger value, and as the degree of brightness is lower, the adjustment amount Δ is set to a larger value.

Upon recognizing the degree of opening of the current position and the degree of brightness of the current position, the processing unit 120 refers to the calculation table (FIG. 10) according to the recognized degree of opening and degree of brightness to calculate the adjustment amount Δ suitable for the current position.

The processing unit 120 adjusts the start time of the lighting permission period to a time earlier than the standard start time by a predetermined adjustment amount Δ, and sets the end time of the lighting permission period to a time later than the standard end time by a predetermined adjustment amount Δ.

Therefore, in a case where the adjustment amount Δ is a positive value (plus value), the lighting permission period is enlarged, and in a case where the adjustment Δ is a negative value (minus value), the lighting permission period is reduced.

### 1-10. Flow

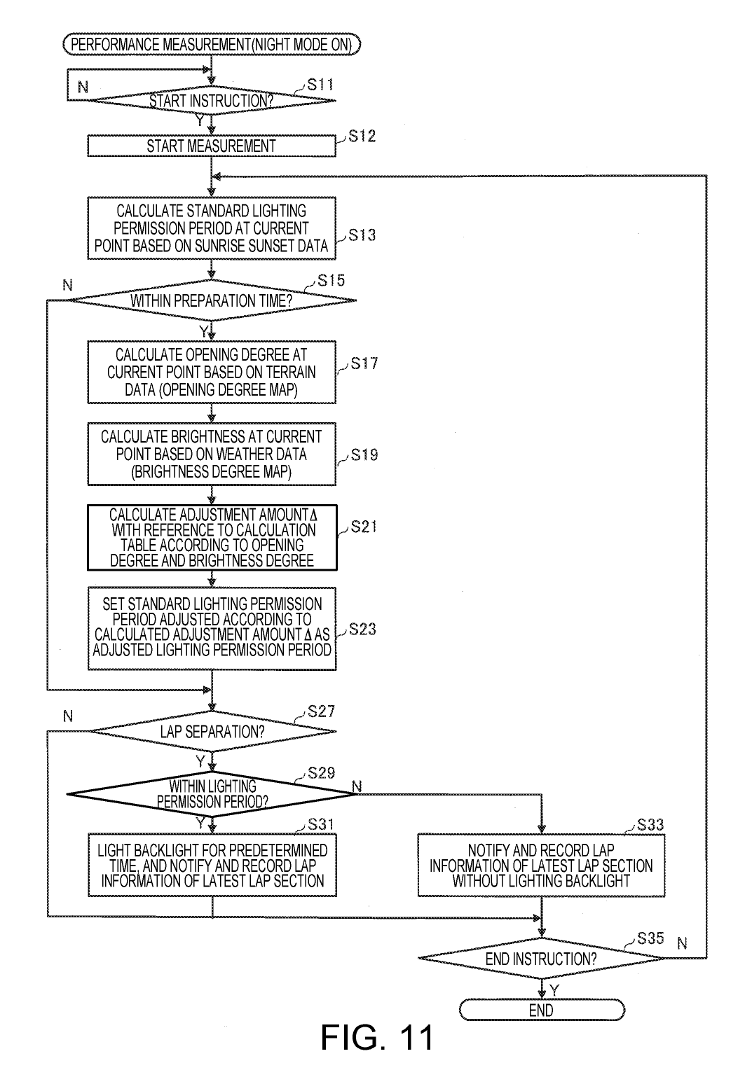

FIG. 11 is a flowchart of a process of the electronic device 1 in a case where a night mode function and an automatic lap function are turned on. Each process in FIG. 11 will be described below in order. Here, it is assumed that the automatic adjustment function of the night mode is turned on.

First, the processing unit 120 of the electronic device 1 determines whether or not a measurement start instruction has been input from the user (S11) and is on standby in a case where there is no input (N at S11).

Thereafter, if the measurement start instruction is input (Y at S11), the processing unit 120 starts measurement of the lap section (S12). Here, the measurement of the lap section refers to a process for generating lap information from the previous lap separation to the next lap separation. For example, in a case where the lap section is set to “1 km section”, it is a process of generating lap information to be notified or recorded in the separation of a section of 1 km (a lap time, a lap pace, a lap heart rate, target achievement thereof, and the like) (hereinafter, it is assumed that the lap section is “1 km section”).

Next, the processing unit 120 calculates a standard lighting permission period (standard start time and standard end time) based on the current position included in the latest positioning data, the current time included in the latest time data, and the sunrise sunset data 136 (S13). The initial lighting permission period is set to be the same as the standard lighting permission period.

Next, the processing unit 120 determines whether or not the current time included in the time data of the timekeeping unit 160 belongs to the preparation period (S15). Here, the preparation period is a predetermined time before and after the start time of the lighting permission period being set and a predetermined time before and after the end time of the lighting permission period being set. For example, the processing unit 120 sets 3 hours before and after the start time and 3 hours before and after the end time as the preparation period.

In a case where the current time belongs to the preparation period (Y at S15), the processing unit 120 starts the adjustment process (S17 to S23). Otherwise (N at S15), the processing unit 120 starts a lap separation determination process (S27) without executing the adjustment process (S17 to S23).

Next, if the adjustment process (S17 to S23) is started, first, the processing unit 120 calculates the degree of opening of the current position based on the current position and the terrain data (opening degree map) (S17).

Next, the processing unit 120 calculates the degree of brightness of the current position based on the current position and the weather data (brightness degree map) (S19).

Next, the processing unit 120 calculates an adjustment amount Δ suitable for the current position by referring to the calculation table (FIG. 10) based on the calculated degree of opening and the calculated degree of brightness (S21).

Next, the processing unit 120 adjusts the lighting permission period according to the calculated adjustment amount Δ (S23). The adjustment method of the lighting permission period is as described above.

Next, if the lap separation determination process (S27) is started, the processing unit 120 determines whether or not the cumulative moving distance from the previous lap separation time (or a time when a start instruction is input) to the current time has reached 1 km (S27). In the case of reaching (Y at S27), the notification process (S29 to S33) is started. Otherwise (N at S27), the notification process (S29 to S33) is skipped and the process proceeds to the end determination process (S35).

If the notification process (S29 to S33) is started, first, the processing unit 120 determines whether or not the current time included in the time data of the timekeeping unit 160 belongs to the lighting permission period being set (S29). In a case where the current time belongs (Y at S29), the notification process (S31) accompanied with lighting of the backlight 170A is started, and otherwise (N at S29), a notification process (S33) not accompanied with lighting of the backlight 170A is started.

If the notification process (S31) accompanied with lighting of the backlight 170A is started, the processing unit 120 lights the backlight 170A of the display unit 170 for a predetermined time (for example, two seconds), notifies the user of the lap information of the latest lap section (a lap time, a lap pace, a lap heart rate, target achievement thereof, or the like), and records the lap information in the user performance data 133. The notification of the lap information to the user is mainly performed by displaying an image on the display unit 170, but may also be accompanied by an output (notification) of sound or vibration. Thereafter, the processing unit 120 proceeds to the end determination process (S35).

If the notification process (S33) not accompanied with lighting of the backlight 170A is started, the processing unit 120, without lighting the backlight 170A of the display unit 170, notifies the user of the lap information of the latest lap section (a lap time, a lap pace, a lap heart rate, target achievement thereof, or the like), and records the lap information in the user performance data 133. The notification of the lap information to the user is mainly performed by displaying an image on the display unit 170, but may also be accompanied by an output (notification) of sound or vibration. Thereafter, the processing unit 120 proceeds to the end determination process (S35).

If the end determination process (S35) is started, the processing unit 120 determines whether or not a measurement end instruction has been input from the user (S35). As long as an input is not made (N at S35), the processing unit 120 repeats the above steps S13 to S33.

Thereafter, in a case where the measurement end instruction is input from the user (Y at S35), the processing unit 120 ends the flow.

In addition, the order of the steps in the above flow can be replaced within a possible range.

### 1-11. Supplement of First Embodiment

The processing unit 120 of the present embodiment performs the same process in the preparation period to which the start time of the lighting permission period belongs (start preparation period) and the preparation period to which the end time of the lighting permission period belongs (end preparation period), but may perform different processes.

For example, the processing unit 120 may adjust only the start time between the start time and the end time of the lighting permission period in the start preparation period, and adjust only the end time between the start time and the end time of the lighting permission period in the end preparation period.

Further, the processing unit 120 of the present embodiment may change the frequency of reviewing the lighting permission period (execution frequency of steps S17 to S23) between the period closer to and the period far from the lighting permission period, in the preparation period. For example, in the period closer to the lighting permission period, the frequency of reviewing the lighting permission period (execution frequency of steps S17 to S23) may be set high. In the period far from the lighting permission period, the frequency of reviewing the lighting permission period (execution frequency of steps S17 to S23) may be set low.

### 1-12. Effect of First Embodiment

As described above, the electronic device 1 of the present embodiment includes the display unit 170 and the processing unit 120, and the processing unit 120 operates in a night mode that improves the lighting frequency or the lighting brightness of the backlight 170A in a period from standard sunset to standard sunrise than the lighting frequency or the lighting brightness of the lighting of the display unit in a period from standard sunrise to standard sunset. Therefore, the electronic device 1 of the present embodiment enables a reduction in power consumption of the display unit 170 during the daytime and securing visibility of the display unit 170 during the night.

However, depending on the environment where the user is located, the timing at which the periphery of the user starts to become dark does not necessarily match the sunset time, and the timing at which the periphery of the user starts to brighten does not necessarily match the sunrise time. For example, according as when the user is at the summit or when the user is in a building street, the angular ranges of sunlight reachable to the user's positions are different such that the lengths of bright time zone of the day are different. For example, according as when the weather of the vicinity of the user is clear or when it is cloudy, the amounts of sunlight reachable to the user's positions are different such that the lengths of the time zone of a day when the visibility of the display unit can be secured are different. Therefore, the start time or the end time of the lighting permission period may be inappropriate depending on the environment where the user is located.

However, the processing unit 120 of the present embodiment can adjust the start time or the end time of the lighting permission period in the night mode according to the input information. Thus, the electronic device 1 of the present embodiment can prevent the start time or the end time of the lighting permission period from becoming inappropriate.

### 2. Second Embodiment

The electronic device 1 of the first embodiment described above executes the automatic adjustment of the night mode based on the terrain data (opening degree map) and the weather data (brightness data), but can also execute the automatic adjustment based on the output of a sensor. Hereinafter, an embodiment based on the output of the sensor will be described as a second embodiment. Here, differences from the first embodiment are mainly described, and common components are denoted by common reference numerals, and detailed description thereof is omitted. In addition, elements common to those in the first embodiment are denoted by common reference numerals.

### 2-1. Configuration of Electronic Device

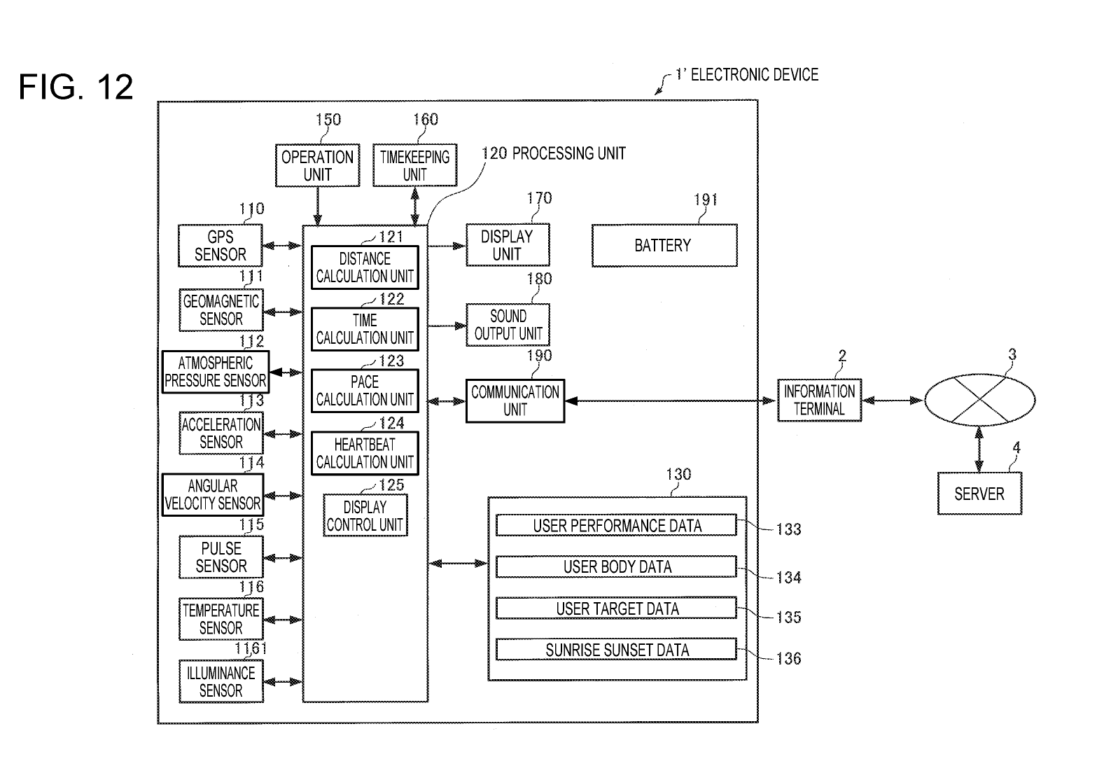

FIG. 12 is a functional block diagram for explaining a configuration of a system including an electronic device of a second embodiment. In FIG. 12, the same reference numerals are attached to the same elements as those illustrated in FIG. 2.

As illustrated in FIG. 12, the electronic device 1′ (an example of a portable electronic device) of the present embodiment is obtained by adding an illuminance sensor 1161 to the electronic device 1 of the first embodiment. Further, it is not essential that the terrain data (opening degree map) 137 and the weather data (brightness degree map) 138 are stored in the storage unit 130 of the electronic device 1′ of the present embodiment.

The illuminance sensor 1161 is a sensor that is provided, for example, in the vicinity of the display unit 170, and generates data (an example of information generated based on the output of a sensor) of the brightness of an environment where a user is located, based on the amount of incident light from the outside.

The processing unit 120 detects the brightness of the environment based on the data of the illuminance sensor 1161 and adjusts the lighting permission period based on the brightness. For example, in a case where the brightness is lower than a predetermined threshold, the lighting permission period is enlarged by a predetermined adjustment amount Δ, and in a case where the brightness exceeds a predetermined threshold, the lighting permission period is reduced.

For example, in a case where the brightness is lower than the predetermined threshold, the processing unit 120 adjusts the start time of the lighting permission period to a time earlier than the standard start time by a predetermined adjustment amount Δ, and sets the end time of the lighting permission period to a time later than the standard end time by a predetermined adjustment amount Δ (see the symbol Δ in FIG. 7).

On the other hand, in a case where the brightness exceeds the predetermined threshold, the processing unit 120 adjusts the start time of the lighting permission period to a time later than the standard start time by a predetermined adjustment amount Δ, and sets the end time of the lighting permission period after adjustment to a time earlier than the standard end time by a predetermined adjustment amount Δ.

On the other hand, in a case where the brightness is the same as the predetermined threshold, the processing unit 120 sets the adjustment amount Δ to zero. That is, the lighting permission period is set to be the same as the standard lighting permission period.

It is assumed that the processing unit 120 of the present embodiment appropriately adjusts the brightness threshold and the adjustment amount Δ according to the current time and the standard lighting permission period.

Specifically, when the current time belongs to the start preparation period, the processing unit 120 executes adjustment such that as the remaining time from the current time to the standard start time is longer and the brightness is lower, the lighting start time comes earlier.

In addition, when the current time belongs to the end preparation period, the processing unit 120 executes adjustment such that as the remaining time from the current time to the standard end time is longer and the brightness is lower, the lighting end time comes later.

### 2-2. Flow

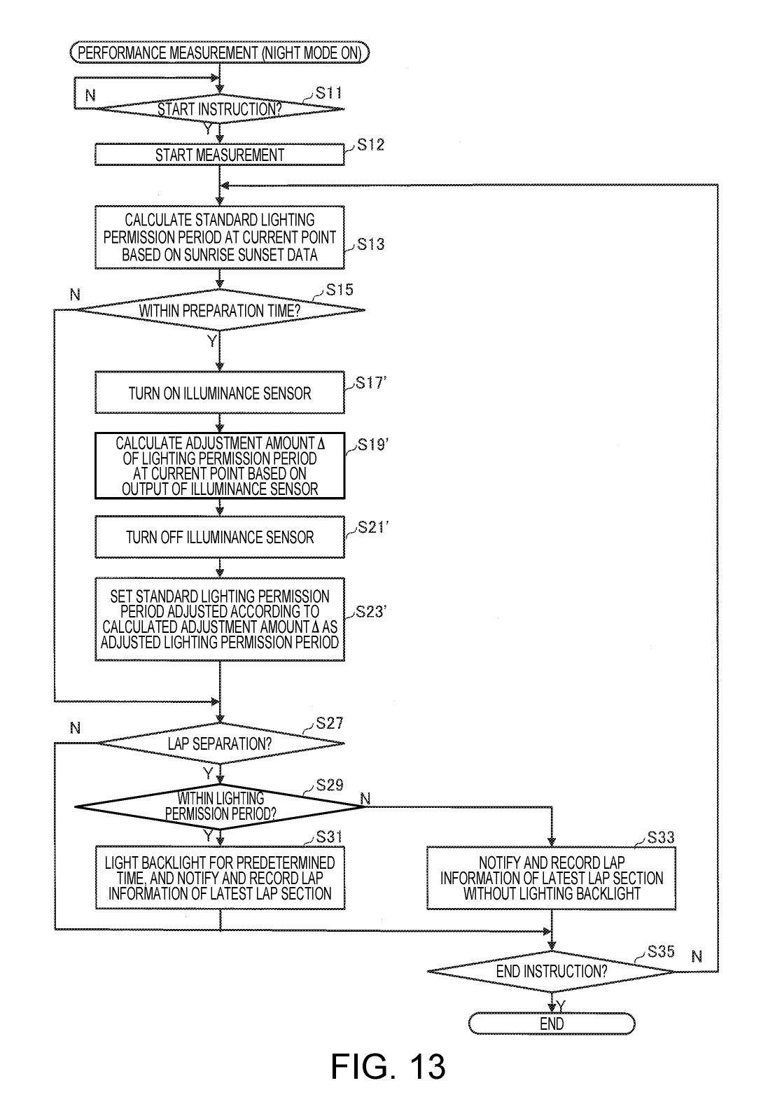

FIG. 13 is a flowchart of a process of the electronic device 1 in a case where a night mode function and an automatic lap function are turned on. Each process in FIG. 13 will be described below in order. Here, it is assumed that the automatic adjustment function of the night mode is turned on. In FIG. 13, the same reference numerals are attached to the same steps as those illustrated in FIG. 11.

First, the processing unit 120 of the electronic device 1 determines whether or not a measurement start instruction has been input from the user (S11) and is on standby in a case where there is no input (N at S11).

Thereafter, if the measurement start instruction is input (Y at S11), the processing unit 120 starts measurement of the lap section (S12). Here, the measurement of the lap section refers to a process for generating lap information from the previous lap separation to the next lap separation. For example, in a case where the lap section is set to “1 km section”, it is a process of generating lap information to be notified or recorded in the separation of a section of 1 km (a lap time, a lap pace, a lap heart rate, target achievement thereof, and the like) (hereinafter, it is assumed that the lap section is “1 km section”).

Next, the processing unit 120 calculates a standard lighting permission period (standard start time and standard end time) based on the current position included in the latest positioning data, the current time included in the latest time data, and the sunrise sunset data 136 (S13). The initial lighting permission period is set to be the same as the standard lighting permission period.

Next, the processing unit 120 determines whether or not the current time included in the time data of the timekeeping unit 160 belongs to the preparation period (S15). Here, the preparation period is a predetermined time before and after the start time of the lighting permission period being set and a predetermined time before and after the end time of the lighting permission period being set. For example, the processing unit 120 sets 3 hours before and after the start time and 3 hours before and after the end time as the preparation period.

In a case where the current time belongs to the preparation period (Y at S15), the processing unit 120 starts the adjustment process (S17 to S23). Otherwise (N at S15), the processing unit 120 starts a lap separation determination process (S27) without executing the adjustment process (S17 to S23).

Next, if the adjustment process (S17′ to S23′) is started, first, the processing unit 120 turns on the illuminance sensor 1161 (S17′). “Turning on the illuminance sensor 1161” means to supply power from the battery 191 to the illuminance sensor 1161.

Next, the processing unit 120 detects the brightness of the current position based on the output of the illuminance sensor 1161, and calculates the adjustment amount Δ based on the brightness or the like (S19′). The calculation method of the adjustment amount Δ is as described above.

Next, the processing unit 120 turns off the illuminance sensor 1161 (S21′). “Turning off the illuminance sensor 1161” means to stop power supply to the illuminance sensor 1161 from the battery 191.

Next, the processing unit 120 adjusts the lighting permission period according to the calculated adjustment amount Δ (S23′). The adjustment method of the lighting permission period is as described above.

Next, if the lap separation determination process (S27) is started, the processing unit 120 determines whether or not the cumulative moving distance from the previous lap separation time (or a time when a start instruction is input) to the current time has reached 1 km (S27). In the case of reaching (Y at S27), the notification process (S29 to S33) is started. Otherwise (N at S27), the notification process (S29 to S33) is skipped and the process proceeds to the end determination process (S35).

If the notification process (S29 to S33) is started, first, the processing unit 120 determines whether or not the current time included in the time data of the timekeeping unit 160 belongs to the lighting permission period being set (S29). In a case where it belongs (Y at S29), a notification process (S31) accompanied with lighting of the backlight 170A is started, and otherwise (N at S29), a notification process (S33) not accompanied with lighting of the backlight 170A is started.

If the notification process (S31) accompanied with lighting of the backlight 170A is started, the processing unit 120 lights the backlight 170A of the display unit 170 for a predetermined time (for example, two seconds), notifies the user of the lap information of the latest lap section (a lap time, a lap pace, a lap heart rate, target achievement thereof, or the like), and records the lap information in the user performance data 133. The notification of the lap information to the user is mainly performed by displaying an image on the display unit 170, but may also be accompanied by an output (notification) of sound or vibration. Thereafter, the processing unit 120 proceeds to the end determination process (S35).

If the notification process (S33) not accompanied with lighting of the backlight 170A is started, the processing unit 120, without lighting the backlight 170A of the display unit 170, notifies the user of the lap information of the latest lap section (a lap time, a lap pace, a lap heart rate, target achievement thereof, or the like), and records the lap information in the user performance data 133. The notification of the lap information to the user is mainly performed by displaying an image on the display unit 170, but may also be accompanied by an output (notification) of sound or vibration. Thereafter, the processing unit 120 proceeds to the end determination process (S35).

If the end determination process (S35) is started, the processing unit 120 determines whether or not a measurement end instruction has been input from the user (S35). As long as an input is not made (N at S35), the processing unit 120 repeats the above steps S13 to S33.

Thereafter, in a case where the measurement end instruction is input from the user (Y at S35), the processing unit 120 ends the flow.

In addition, the order of the steps in the above flow can be replaced within a possible range.

### 2-3. Supplement of Second Embodiment

As described above, since the electronic device 1′ of the present embodiment uses the output of the illuminance sensor 1161 for adjustment of the lighting permission period, it is possible to respond flexibly to the actual brightness of the environment where the user is located.

Further, since the electronic device 1′ of the present embodiment limits the period during which the illuminance sensor 1161 is turned on only to the preparation period, it is also possible to reduce the power consumption required for driving the illuminance sensor 1161 to a minimum.

In addition, the processing unit 120 of the present embodiment can further reduce the power consumption by reducing the frequency of executing the process of steps S15 to S23′ (that is, reducing the frequency at which the illuminance sensor 1161 is driven).

Further, the processing unit 120 of the present embodiment detects the brightness of the environment where the user is located by using the output of the illuminance sensor 1161, but instead of detecting the brightness of the environment where the user is located, may estimate the brightness of the environment where the user is located by using the output of the atmospheric pressure sensor 112 and the current position (altitude) included in the positioning data of the GPS sensor 110. For example, the processing unit 120 can estimate that it is cloudy (that is, dark) when the atmospheric pressure is lower at the altitude, and can estimate that it is clear (bright) when the atmospheric pressure is higher at the altitude.

The processing unit 120 of the present embodiment may perform the following processes respectively, in the preparation period to which the start time of the lighting permission period belongs (start preparation period) and the preparation period to which the end time of the lighting permission period belongs (end preparation period).

For example, in the start preparation period, in a case where the detected brightness is below a predetermined threshold, the processing unit 120 may start the lighting permission period and interrupt the preparation period. In the end preparation period, in a case where the detected brightness exceeds the predetermined threshold, the processing unit 120 may end the lighting permission period and interrupt the preparation period (in this case, the threshold may be fixed to a predetermined value).

Further, the processing unit 120 of the present embodiment may change the frequency of reviewing the lighting permission period (execution frequency of steps S17′ to S23′) between the period closer to and the period far from the lighting permission period, in the preparation period. For example, in the period closer to the lighting permission period, the frequency of reviewing the lighting permission period (execution frequency of steps S17′ to S23′) may be set high. In the period far from the lighting permission period, the frequency of reviewing the lighting permission period (execution frequency of steps S17′ to S23′) may be set low. Thus, it is possible to efficiently reduce the power consumption required for driving the illuminance sensor 1161.

### 3. MODIFICATION EXAMPLE

### 3-1. Lighting Pattern

The processing unit 120 of any of the embodiments described above may change the lighting pattern of the backlight 170A according to the contents of information reported by the automatic notification function. For example, the lighting pattern may be changed in a case where the actual lap time is shorter than the target lap time (in a case where the target is achieved) or when the lap time is longer (in a case where the target is not achieved).

In a case where the target is achieved, the processing unit 120 lights the backlight 170A at a timing when the user gestures to view the display unit 170. When the target is not achieved, the processing unit 120 constantly lights the backlight 170A even if it is not the timing when the user gestures to see, and when target achievement becomes significantly low (or when the target achievement becomes significantly high), the backlight 170A may always be blinking even if it is not the timing when the user gestures to see.

In any of the above-described embodiments, the light sources of the backlight 170A may be pluralized, and the colors of the plurality of light sources may be different from each other. In this case, the processing unit 120 may change the lighting color according to the contents of information to be notified (the display unit 170 may be configured with a color display, and display color may be changed).

Further, the processing unit 120 of any of the embodiments described above may change the lighting illumination (lighting brightness) of the backlight 170A according to the remaining amount of the battery 191. For example, as the remaining amount is small, the lighting illuminance may become dark step by step. Thus, power saving can further be achieved.

Further, in a case where there is a change in the user performance data generated based on the output of at least one sensor, or in a case where measurement of the user performance data is impossible, the processing unit 120 of any of the embodiments described above may switch the backlight 170A from the lit state to the blinking state, thereby making a notification to the user. For example, when the pulse wave cannot be measured, a notification to the user (or a notification to the vicinity of the user) is effective to inform the user of the danger or abnormality.

Further, when the electronic devices 1 and 1′ are set to a long time mode, the processing unit 120 of any of the embodiments described above may automatically (forcibly) set the electronic devices 1 and 1′ to a night mode. “Long-time mode” is a mode that extends the life of the battery 191 by intermittently driving at least some elements (circuits, or the like) of the electronic devices 1 and 1′.

In a case where it is determined that the receiving environment of satellite signals (GPS signals) is bad based on the positioning data (in a case where the receiving strength is weak or the number of supplementary satellites is small), the processing unit 120 of the first embodiment described above may determine that the degree of opening described above is low, and in a case where it is determined that the receiving environment is good, the processing unit 120 may determine that the degree of opening described above is high. In addition, the processing unit 120 of the first embodiment may notify the user of the quality of the reception environment by the lighting pattern of the backlight 170A.

Further, the processing unit 120 of any of the embodiments described above may change the lighting illumination (brightness) of the backlight 170A, depending on the contents of the information to be notified to the user.

Further, the processing unit 120 of the second embodiment may set a period during which the environment where the user is located can be determined to be bright as the lighting permission period and a period during which it is not bright as the lighting prohibited period, based on the output of the illuminance sensor 1161.

In the above-described second embodiment, brightness may be estimated using at least one of a solar panel (the amount of generated electricity) and an ultraviolet sensor (the amount of ultraviolet rays), instead of the illuminance sensor 1161 or in addition to the illuminance sensor 1161.

In addition, the processing unit 120 of any of the above-described embodiments determines that a lighting instruction of the backlight 170A is input in a case where the user presses a predetermined operation button (operation button 150B), but the processing unit 120 may determine that the lighting instruction of the backlight 170A is input in a case where the user gestures to view the display unit 170.

Further, the processing unit 120 of any of the embodiments described above may light the backlight 170A at a timing when the user presses the predetermined operation button (operation button 150B), regardless of whether or not it is a lighting prohibited period (forced lighting mode).

Alternatively, even in a case where the operation button 150B is pressed down, if it is the lighting prohibited period, the processing unit 120 of any of the above-described embodiments may necessarily turn off the backlight 170A (non-forced lighting mode).

Alternatively, the processing unit 120 of any of the above-described embodiments may allow the user to designate in advance whether to operate the backlight 170A in the forced lighting mode described above or the non-forced lighting mode described above.

The processing unit 120 of any of the above-described embodiments may develop at least one (or more than two combinations) of the above various functions in the electronic devices 1 and 1′ according to the user's setting.

### 3-2. Variation of Lap Information

Although the processing unit 120 of the electronic device 1 of the present embodiment adds at least one of the lap time, the lap distance, the lap pace, and the lap heart rate to the lap information to be notified and recorded, but may add other types of lap information. The lap information is obtained by measuring user performance data (or user activity amount data) for each lap section. An example of the user performance data (or user activity amount data) will be described later, but hereinafter, some data that can be adopted as lap information will be explained.

For example, the processing unit 120 may add at least one of a maximum oxygen intake amount (VO₂ max) and a minimum oxygen intake amount (VO₂ min) to one piece of lap information to be notified and recorded.

Here, the maximum oxygen intake amount (VO₂ max) is the maximum oxygen intake amount of the user in the lap section. An oxygen intake amount can be calculated (estimated) according to a predetermined arithmetic expression using parameter values such as age, sex, and body weight of the user. Since the arithmetic expression itself is well known, the explanation thereof will be omitted here.

The processing unit 120 of the above embodiment may add at least one of the item of the maximum pulse rate and the item of the minimum pulse rate to one of the lap information to be notified and recorded.

Here, the maximum pulse rate “HRmax” is the maximum pulse rate of the user in the lap section, and can be calculated by “HRmax=220−age of the user”, for example. The minimum pulse rate “HRmin” is the minimum pulse rate of the user in the lap section, and can be set as the pulse rate at rest, for example. A typical adult's pulse rate at rest is about “60 to 70”. The pulse rate at rest is determined based on the sex and age of the user, from this range, and the minimum pulse rate can be set as “HRmin”.

### 3-3. Regarding User Performance Data

Further, the processing unit 120 of the above embodiment may generate and record at least one of the following user performance data.

Example of the user performance data: an exercise distance (a moving distance, a cumulative moving distance), an exercise time, an exercise time in a predetermined heartbeat zone, a step count, a lap step count, a travel pace, a travel pitch, strides, a split time, a lap time, a cumulative ascending altitude, a cumulative descending altitude, elevation (average altitude of an exercise place), a slope, a training count (a running count, maximum, average, or the like), a degree of target achievement, posture (running posture), a left and right difference, a contact time, immediate landing rate, propulsive efficiency, leg flow, a landing brake amount, landing impact, a heart rate, burned calories, an oxygen intake amount, a perspiration amount, a water intake amount, an expected moving distance under predetermined conditions (a moving distance, an expected cumulative distance), a time to reach a predetermined heartbeat zone, an expected pace under predetermined conditions, an expected pitch under predetermined conditions, an expected stride (predetermined stride) under predetermined conditions, an expected time under predetermined conditions (a lap time, a split time), an expected burned calories under predetermined conditions, an automatically generated target, an ultraviolet ray amount, VO₂max, Sp0₂ (arterial blood oxygen saturation, an estimated value), user performance data for each item, or the like.

### 3-4. Regarding User Activity Amount Data

Further, the processing unit 120 of the above embodiment may generate and record at least one of the following user activity data.

Examples of the user activity amount data: a moving distance, an exercise time, a step count, walking pace, walking pitch, strides, a fast walking step count, a running step count, the number of rising floors (“five floors”, “two floors” or the like), the number of rising stairs (“100 stairs”, “200 stairs”, or the like), a heart rate, a sleeping time, stress (balance between an excited state and a relaxed state), an oxygen intake amount, a perspiration amount, a water intake amount (manual input by the user), burned calories, calorie intake (manual input by the user), calorie balance, weight (input by communication with a scale, or manual input by a user), a waist size (manual input by a user), balance between tension time and relaxation time (heart balance), a heart rate, target achievement, an ultraviolet ray amount, VO₂max, SpO₂ (arterial blood oxygen saturation, an estimated value), sleep state (percentage or score of deep, shallow, good, bad, or the like).

### 3-5. Regarding Sensor Type

The electronic device 1 of the above embodiment can use at least one of the following various sensors as a sensor. That is, it is an acceleration sensor, a GPS (GNSS) sensor, an angular velocity sensor, a speed sensor, a heartbeat sensor (such as chest belt), a pulse sensor (sensor performing measurement at places other than the heart), a pedometer, a pressure sensor, an altitude sensor, a temperature sensor (an air temperature sensor and a body temperature sensor), a geomagnetic sensor, a weight scale (used as an external device of the electronic device 1), an ultraviolet sensor, a sweat amount sensor, a blood pressure sensor, a blood oxygen concentration (SpO₂) sensor, a lactate sensor, a blood glucose sensor, and the like.

### 3-6. Regarding Data Aggregation Method

In the processing unit 120 of the above embodiment, it is possible to notify the user of at least one of a representative value (a best value or a worst value) in the lap section, a cumulative value in the lap section, transition in the lap section, a ratio in the lap section, variation in the lap section (such as the largeness or smallness of the variation), a degree of target achievement in the lap section, an expected value calculated from data in the lap section, a target value calculated from the data in the lap section, an evaluation result of the lap section (a score, a level, a percentage of good portions, or the like), as at least one piece of lap information, in addition to the average value in the lap section.

### 3-7. Regarding Graph Display

The processing unit 120 of the above embodiments may represent data in the lap section by a numerical value, or may represent data by another type of graph such as a bar graph or a line graph.

Although the processing unit 120 of the embodiments described above represents at least one data by a numerical image, the numerical image may be switched in time series when the user continuously presses a predetermined operation button (or repeatedly presses). Alternatively, the processing unit 120 of the above embodiments may allow numerical transitions to be listed by arranging a plurality of numerical images on the screen.

Further, the processing unit 120 of the above embodiments may display at least one data together with the target of the item (target and result). In that case, the processing unit 120 may highlight the data when the data of a certain item reaches the target. The highlighting of data is performed by changing, inverting, flickering or marking at least one of the contrast, brightness, color, and saturation of data, by enlarging the display size of data, or the like.

Further, the processing unit 120 of the above embodiments may display at least one combination of (i) target and result, (ii) result and expectation, (iii) maximum, minimum and average for at least one item side by side.

### 3-8. Regarding Notification Form

Further, the electronic device 1 or information terminal 2 may perform a notification of information to the user by image display, and in addition to the image display, the notification may be performed by sound output, vibration, light, color (light emission of LED or display color of a display), or the like, or may be performed by a combination of at least two of image display, sound output, vibration, light, and color.

### 3-9. Regarding User Setting

Further, in the above embodiments, the user directly inputs information to the electronic device 1, but the user may indirectly perform input through the information terminal 2. The information terminal 2 may allow the user to input information necessary for setting the electronic device 1, and the information terminal 2 may transfer the information to the electronic device 1 in an environment enabling communication with the electronic device 1.

### 3-10. Regarding other Customization

In addition, the user may set in advance at least some notification contents to the user (including a notification period, a notification item, a notification mode, an aggregation method, a notification order, or the like) by the processing unit 120 of the above embodiment (customizable).

### 3-11. Regarding Form of Equipment

At least one of the electronic device 1 and the information terminal 2 can be configured as various types of portable information devices such as a list type electronic device, an earphone type electronic device, a ring type electronic device, a pendant type electronic device, an electronic device used by being attached to a sports appliance, a smartphone, a head mount display (HMD), and a head up display (HUD).

### 3-12. Regarding Option Function

Further, at least one of the electronic device 1 and the information terminal 2 may have other functions. Other functions are, for example, a known smartphone function. The smartphone function includes, for example, a call function, a mail incoming notification function, a telephone incoming notification function, a communication function, a camera function, and the like.

### 3-13. Event

In any of the above-described embodiments, the case where the use of the system is running has been described, but the system of the embodiment can be applied to various sports that may be performed at night. For example, the sports are walking, bicycle, and so on.

Further, the system of any embodiment can be applied to any sports that need to limit the lighting permission period of the backlight 170A. In the sports, “Lighting is prohibited during the day” and “Lighting is permitted only at night in predetermined conditions”. It is considered to be effective for sports accompanied by outdoor activities or sports performed for a long time, such as swimming, trail running, climbing, trekking, triathlon, skiing (including cross country skiing or the like), snowboarding, and snowshoe hiking.

In addition to the marathon, running and walking, the system of the present embodiment can be used for various sports such as climbing, trekking, skiing (cross country, snowboarding), snowboarding, snowshoe hiking, bicycle, swimming, triathlon, diet, fitness (collectively: activities), as well as skating, motorbike, boat (rowing), yachting, trail running, paragliding, dog sledding, and equestrianism. The system can also be applied to navigation, rehabilitation and the like, in addition to sports. Further, in the system of the present embodiment, different items maybe logged depending on each use, or the user may select the use or item.

### 3-14. Regarding System Form

In the above embodiments, the information terminal 2 or the electronic device 1 may have some functions of the server 4, or the server 4 may have some functions of the information terminal 2 or the electronic device 1. In the above embodiments, the information terminal 2 may have some or all of the functions of the electronic device 1, the electronic device 1 may have some or all of the functions of the server 4 and the information terminal 2, or the information terminal 2 may have some or all of the functions of the server 4 and the electronic device 1.

### 3-15. Regarding Positioning System

In the above embodiments, a global positioning system (GPS) is used as a global satellite positioning system, but other global navigation satellite system (GNSS) may be used. For example, one or two or more out of satellite positioning systems such as a European geostationary-satellite navigation overlay service (EGNOS), a Quasi Zenith satellite system (QZSS), a global navigation satellite system (GLONASS), GALILEO, and a BeiDou navigation satellite system (BeiDou) may be used. Further, a geostationary satellite-type satellite-based augmentation system (SBAS) such as a wide area augmentation system (WAAS) and a European geostationary-satellite navigation overlay service (EGNOS) may be used for at least one of the satellite positioning systems.

### 4. OTHERS

The invention is not limited to the above embodiments, and various modifications are possible within the scope of the invention.

In addition, each of the above-described embodiments and modification examples is an example, and the invention is not limited thereto. For example, the respective embodiments and the respective modification examples can be appropriately combined.

Further, the invention includes substantially the same configuration (for example, a configuration having the same function, method, and result, or a configuration having the same purpose and effect) as the configuration described in the embodiment. Further, the invention includes configurations in which the non-essential parts of the configuration described in the embodiment are replaced. Further, the invention includes configurations that achieve the same effect as the configuration described in the embodiment or configurations that can achieve the same object. Further, the invention includes configurations in which a well-known technology is added to the configuration described in the embodiment.

The entire disclosure of Japanese Patent Application No. 2016-038785, filed Mar. 1, 2016 is expressly incorporated by reference herein.

What is claimed is:

1. A portable electronic device comprising:
a display unit; and
a processing unit that operates in a mode that improves lighting frequency or lighting brightness of lighting of the display unit during a period from sunset to sunrise than the lighting frequency or the lighting brightness of the lighting during a period from sunrise to sunset, and adjusts a start time or an end time of the period for improving the lighting frequency or the lighting brightness of the lighting in the mode, depending on input information.

2. The portable electronic device according to claim 1, further comprising:
an operation unit,
wherein the input information includes information which is input through the operation unit.

3. The portable electronic device according to claim 1,
wherein the input information includes information which is generated based on an output of a sensor.

4. The portable electronic device according to claim 1, further comprising:
a communication unit,
wherein the input information includes information which is received through the communication unit.

5. The portable electronic device according to claim 1,
wherein the input information includes information on environment where a user is located.

6. The portable electronic device according to claim 1,
wherein the input information includes information on terrain or weather.

7. The portable electronic device according to claim 1,
wherein the portable electronic device is attachable to a user's arm or wrist.

8. A display method for a display unit of a portable electronic device, the method comprising:
operating in a mode that improves lighting frequency or lighting brightness of lighting of the display unit during a period from sunset to sunrise than the lighting frequency or the lighting brightness of the lighting during a period from sunrise to sunset, and adjusting a start time or an end time of the period for improving the lighting frequency or the lighting brightness of the lighting in the mode, depending on input information.

9. The display method according to claim 8, further comprising:
manipulating,
wherein the input information includes information which is input in the manipulating.

10. The display method according to claim 8,
wherein the input information includes information which is generated based on an output of a sensor.

11. The display method according to claim 8, further comprising:
communicating,
wherein the input information includes information which is received in the communicating.

12. The display method according to claim 8,
wherein the input information includes information on environment where a user is located.

13. The display method according to claim 8,
wherein the input information includes information on terrain or weather.
